(19) United States
(12) Patent Application Publication
(10) Pub. No.: US 2012/0045995 A1
(43) Pub. Date: Feb. 23, 2012

(54) INTERFERENCE SUPPRESSION WIRELESS COMMUNICATION SYSTEM AND INTERFERENCE SUPPRESSION WIRELESS COMMUNICATION DEVICE

(76) Inventors: Hiroshi Nakano, Osaka (JP); Minoru Kubota, Osaka (JP); Takashi Onodera, Osaka (JP); Kozue Hirata, Osaka (JP)

(21) Appl. No.: 13/266,065

(22) PCT Filed: Apr. 16, 2010
(86) PCT No.: PCT/JP2010/002773

§ 371 Date: Oct. 24, 2011

(30) Foreign Application Priority Data
Apr. 27, 2009 (JP) 2009-108226

(51) Int. Cl. H04B 15/00

(52) U.S. Cl. 455/63.1

(57) ABSTRACT

An interference suppression wireless communication device to be used in an interference suppression wireless communication system, includes: a variance acquirer configured to acquire a variance of channel estimation errors associated with a channel for a transmission signal of the interference suppression wireless communication device, a variance of channel estimation errors associated with a channel for an interference signal, and a variance of noise included in the transmission signal when the transmission signal is received; and a coefficient calculator configured to calculate, based on the variances acquired by the variance acquirer, a coefficient by which the interference signal to be subtracted from the transmission signal is multiplied.

### TECHNICAL FIELD

The present invention relates to an interference suppression wireless communication system and an interference suppression wireless communication device for suppressing interferences and performing wireless communication.

Priority is claimed on Japanese Patent Application No. 2009-108226, filed Apr. 27, 2009, the content of which is incorporated herein by reference.

### BACKGROUND ART

If a transmission device of a wireless communication system previously knows an interference signal element included in a reception signal of a reception device, the transmission device subtracts the interference signal element from a transmission signal in advance, thereby preventing the reception device from being substantially affected by the interferences.

A method called THP (Tomlinson-Harashima Precoding) has been proposed. The method is a method of suppressing an increase in transmission power which is caused by subtracting an interference signal element when performing communication using the method of subtracting the interference element from a transmission signal. According to the THP, both a transmission device and a reception device perform modulo arithmetic on communication signals, thereby suppressing an increase in the transmission power (see Non-Patent Document 1).

Additionally, a method of further improving the error rate characteristics (reducing the error rate) compared to when the THP is simply used, has been proposed. In the method, when performing communication using the THP, a transmission device multiplies, by a coefficient, an interference signal element to be subtracted from a transmission signal, and thereby transmits the transmission signal without fully cancelling the interferences. Meanwhile, a reception device multiplies a reception signal by the same coefficient. This method is called ILP (Inflated Lattice Precoding) (see Non-Patent Document 2).

FIG. 17 is a diagram illustrating a flow of a signal when communication using the ILP is performed.

In FIG. 17, s denotes a desired signal to be transmitted from a transmission device 1001 to a reception device 1002. A channel between the transmission device 1001 and the reception device 1002 is an AWGN (Additive White Gaussian Noise) channel. The reception device 1002 receives a transmission signal x to which an interference signal element f and a noise n are added. In other words, a reception signal can be expressed as y=x+f+n. The transmission device 1001 previously knows the interference signal element f.

The transmission device 1001 subtracts, from the desired signal s, the interference signal element f multiplied by a coefficient α, performs modulo arithmetic used for the THP, and then transmits a resultant signal as the transmission signal x. The reception device 1002 multiplies a reception signal y by the same coefficient α as used by the transmission device 1001, and performs the same modulo arithmetic as performed by the transmission device 1001. The result of the modulo arithmetic becomes an estimation value for the desired signal acquired on the receiving side, which is denoted as s′.

It has been proposed in Non-Patent Document 2 that the coefficient α is regarded as the expression (1), where σₓ² denotes a variance of the transmission signal x, and σₙ² denotes a variance of a noise n.

$$\begin{matrix}( Expression 1 ) & \\ α = \frac{{σ}_{x}^{2}}{{σ}_{x}^{2} + {σ}_{n}^{2}} & Expression ( 1 )\end{matrix}$$

Non-Patent Document 2 discloses that when the coefficient α is the aforementioned value, a variance of an error s-s′ between the desired signal s on the transmitting side and the estimation value s′ of the desired signal acquired on the receiving side can be expressed as the expression (2). This variance is smaller than the variance σₙ² of the error s-s′ when communication using the THP is simply performed (corresponding to the case of α=1). Accordingly, the error rate characteristics are improved.

$$\begin{matrix}( Expression 2 ) & \\ \frac{{σ}_{x}^{2} {σ}_{n}^{2}}{{σ}_{x}^{2} + {σ}_{n}^{2}} & Expression ( 2 )\end{matrix}$$

### CITATION LIST

### Non-Patent Document

[Non-Patent Document 1] Harashima at al, Matched-Transmission Technique for Channels With Intersymbol Interference, IEEE TRANSACTION ON COMMUNICATIONS, August, 1972, Vol. COM-20, No. 4, p. 774-780

[Non-Patent Document 2] R. F. H. Fischer, The Modulo-Lattice Channel: The Key Feature in Precoding Schemes, AEU-Int. Journal of Electronics and Communications, June, 2005, p. 244-253

### DISCLOSURE OF THE INVENTION

### Problems to be Solved by the Invention

In the THP, and the ILP which has been proposed conventionally, however, it is desirable that when the transmission device calculates an interference signal element included in the reception signal of the reception device, the transmission device precisely knows CSI (Channel State Information) of a channel from an interference source to the reception device at the time of transmission of signals, or the interference signal element included in a signal to be received by the reception device. However, it is actually impossible to precisely know these information pieces, and errors are included in the channel state information CSI or the interference signal element, which is recognizable to the transmission device. Due to the errors, an improvement of the error rate characteristics when the inflated lattice precoding is used has been suppressed.

The present invention has been made in view of the above considerations. An object of the present invention is to provide a communication system and a communication device, which can improve the error rate characteristics under conditions in which errors are included in an interference signal element known by a transmission device.

### Means for Solving the Problems

The present invention has been made to solve the above problems, an interference suppression wireless communication device according to one aspect of the present invention is an interference suppression wireless communication device to be used in an interference suppression wireless communication system. The interference suppression wireless communication device includes: a variance acquirer configured to acquire at least one of a variance of channel estimation errors associated with a channel for a transmission signal of the interference suppression wireless communication device and a variance of channel estimation errors associated with a channel for an interference signal, and acquire a variance of noise included in the transmission signal when the transmission signal is received; and a coefficient calculator configured to calculate, based on the variances acquired by the variance acquirer, a coefficient by which the interference signal to be subtracted from the transmission signal is multiplied.

According to the interference suppression wireless communication device of the one aspect of the present invention, the variance acquirer is configured to generate a variance of the transmission signal, and the coefficient calculator is configured to calculate the coefficient using also the variance of the transmission signal.

According to the interference suppression wireless communication device of the one aspect of the present invention, the variance acquirer is configured to calculate, using the variance of the channel estimation errors associated with the channel for the transmission signal, a variance of errors in channel state information associated with the channel for the transmission signal. The variance acquirer is configured to calculate, using the variance of the channel estimation errors associated with the channel for the interference signal, a variance of errors in channel state information associated with the channel for the interference signal. The variance acquirer is configured to acquire a variance of an interference signal calculated from the interference signal for an interference source, in order to calculate a variance of errors in the interference element.

According to the interference suppression wireless communication device of the one aspect of the present invention, the variance acquirer is configured to acquire the variance of the channel estimation errors associated with the channel for the interference signal. The variance acquirer is configured to acquire, in addition to the variance of the channel estimation errors associated with the channel for the interference signal, at least one of a variance of errors according to granularity for transmitting the channel state information, a variance of errors due to channel variation associated with the channel for the interference signal, and a variance of quantization errors in the channel state information associated with the channel for the interference signal. The variance acquirer is configured to calculate a variance of errors in the channel state information associated with the channel for the interference signal by calculating a sum of the at least one of the variances acquired. The variance acquirer is configured to acquire the variance of the channel estimation errors associated with the channel for the transmission signal. The variance acquirer is configured to acquire, in addition to the variance of the channel estimation errors associated with the channel for the transmission signal, at least one of a variance of errors according to granularity for transmitting the channel state information, a variance of errors due to channel variation associated with the channel for the transmission signal, and a variance of quantization errors in channel state information associated with the channel for the transmission signal. The variance acquirer is configured to calculate a variance of errors in the channel state information associated with the channel for the interference signal by calculating a sum of the at least one of the variances acquired.

According to the interference suppression wireless communication device of the one aspect of the present invention, the variance acquirer is configured to generate, based on a method of transmitting the channel state information associated with the channel for the interference signal, the variance of the quantization errors in the channel state information associated with the channel for the interference signal. The variance acquirer is configured to generate, based on a method of transmitting the channel state information associated with the channel for the transmission signal, the variance of the quantization errors in the channel state information associated with the channel for the transmission signal.

An interference suppression wireless communication device according to one aspect of the present invention, includes: a channel state information acquirer configured to calculate channel state information associated with a channel for an interference signal, and channel state information associated with a channel for a transmission signal; a radio receiver configured to calculate an average reception power of a reception signal; a variance calculator configured to calculate, when communication is initiated and during the communication, a variance of channel estimation errors associated with the channel for the interference signal which are generated when the channel state information associated with the channel for the interference signal is calculated, and a variance of channel estimation errors associated with the channel for the transmission signal which are generated when the channel state information associated with the channel for the transmission signal is calculated; and a radio transmitter configured to transmit the channel state information associated with the channel for the interference signal, the channel state information associated with the channel for the transmission signal, the variance of the channel estimation errors associated with the channel for the interference signal, and the variance of the channel estimation errors associated with the channel for the transmission signal.

According to the interference suppression wireless communication device of the one aspect of the present invention, the radio receiver is configured to further calculate a delay spread of the reception signal. The variance calculator is configured to further calculate, when communication is initiated and during the communication, errors according to granularity for transmitting the channel state information associated with the channel for the interference signal, and errors according to granularity for transmitting the channel state information associated with the channel for the transmission signal. The radio transmitter is configured to further transmit the errors according to the granularity for transmitting the channel state information associated with the channel for the interference signal, and the errors according to the granularity for transmitting the channel state information associated with the channel for the transmission signal.

According to the interference suppression wireless communication device of the one aspect of the present invention, the radio receiver is configured to further calculate a maximum Doppler frequency of the reception signal. The variance calculator is configured to further calculate, when communication is initiated and during the communication, a variance of the channel variation errors associated with the channel for the interference signal, and a variance of the channel variation errors associated with the channel for the transmission signal. The radio transmitter is configured to further transmit the variance of the channel variation errors associated with the channel for the interference signal, and the variance of the channel variation errors associated with the channel for the transmission signal.

The interference suppression wireless communication device of the one aspect of the present invention, further includes a plurality of antennas. The radio signal generator is configured to simultaneously transmit a plurality of desired signals using the same frequency. The coefficient calculator is configured to calculate the coefficient using a variance of channel estimation errors associated with a channel for each of the plurality of desired signals and the variance of the noise.

An interference suppression wireless communication device according to one aspect of the present invention is an interference suppression wireless communication device to be used in an interference suppression wireless communication system. The interference suppression wireless communication device includes: a channel state information calculator configured to calculate a channel estimation value associated with a channel for an interference signal, and a channel estimation value associated with a channel for a transmission signal; a variance calculator configured to calculate a variance of channel estimation errors associated with the channel for the transmission signal, a variance of channel estimation errors associated with the channel for the interference signal, and a variance of noise; and a radio transmitter configured to transmit the channel estimation value associated with the channel for the interference signal, the channel estimation value associated with the channel for the transmission signal, the variance of the channel estimation errors associated with the channel for the transmission signal, the variance of the channel estimation errors associated with the channel for the interference signal, and the variance of noise.

An interference suppression wireless communication system according to one aspect of the present invention includes: a first communication device; a second communication device; and a third communication device. The first communication device includes: an interference source transmission signal acquirer configured to receive an interference source transmission signal; a radio receiver configured to receive channel state information associated with a channel for an interference signal; an interference signal calculator configured to multiply the interference source transmission signal by the channel state information associated with the channel for the interference signal, to calculate an interference signal estimation value; a variance acquirer configured to acquire at least one of a variance of channel estimation errors associated with the channel for the transmission signal and a variance of channel estimation errors associated with the channel for the interference signal, and acquire a variance of noise; a coefficient calculator configured to calculate a coefficient based on the at least one of the variance of the channel estimation errors associated with the channel for the transmission signal and the variance of the channel estimation errors associated with the channel for the interference signal, and the variance of noise, which are acquired; a coefficient multiplier configured to multiply the interference signal estimation value by the coefficient, to calculate a subtraction signal; an interference signal subtractor configured to subtract the subtraction signal from a desired signal to be transmitted, to calculate a post-subtraction signal; a modulo unit configured to divide the post-subtraction signal by a predetermined value to obtain a remainder, to calculate a power suppression transmission signal; and a radio signal generator configured to transmit a transmission signal based on the power suppression transmission signal. The second communication device includes: a channel state information calculator configured to calculate a channel estimation value associated with a channel for an interference signal, and a channel estimation value associated with a channel for a transmission signal; a variance calculator configured to calculate a variance of channel estimation errors associated with the channel for the transmission signal, a variance of channel estimation errors associated with the channel for the interference signal, and a variance of noise; and a radio transmitter configured to transmit the channel estimation value associated with the channel for the interference signal, the channel estimation value associated with the channel for the transmission signal, the variance of the channel estimation errors associated with the channel for the transmission signal, the variance of the channel estimation errors associated with the channel for the interference signal, and the variance of noise. The third communication device includes: a radio signal generator configured to transmit an interference signal; and an interference source transmission signal notifier configured to transmit a transmission signal of the third communication device as an interference source transmission signal.

An interference suppression wireless communication system according to one aspect of the present invention includes: a first communication device; and a second communication device. The first communication device includes: an interference signal calculator configured to acquire channel state information associated with a channel for an interference signal, and multiply a transmission signal of the first communication device by the channel state information associated with the channel for the interference signal, to calculate an interference signal estimation value; a variance acquirer configured to acquire at least one of a variance of channel estimation errors associated with the channel for the transmission signal and a variance of channel estimation errors associated with the channel for the interference signal, and acquire a variance of noise; a coefficient calculator configured to calculate a coefficient based on the least one of the variance of the channel estimation errors associated with the channel for the transmission signal and the variance of the channel estimation errors associated with the channel for the interference signal, and the variance of noise, which are acquired; a coefficient multiplier configured to multiply the interference signal estimation value by the coefficient to calculate a subtraction signal; an interference signal subtractor configured to subtract the subtraction signal from a desired signal to be transmitted, to calculate a post-subtraction signal; a modulo unit configured to divide the post-subtraction signal by a predetermined value to obtain a remainder, to calculate a power suppression transmission signal; and a radio signal generator configured to transmit a transmission signal based on the power suppression transmission signal. The second communication device includes: a channel state information calculator configured to calculate a channel estimation value associated with a channel for an interference signal, and a channel estimation value associated with a channel for a transmission signal; a variance calculator configured to calculate a variance of channel estimation errors associated with the channel for the transmission signal, a variance of channel estimation errors associated with the channel for the interference signal, and a variance of noise; and a radio transmitter configured to transmit the channel estimation value associated with the channel for the interference signal, the channel estimation value associated with the channel for the transmission signal, the variance of the channel estimation errors associated with the channel for the transmission signal, the variance of the channel estimation errors associated with the channel for the interference signal, and the variance of noise.

### Effects of the Invention

According to the present invention, the wireless communication system can improve the error rate characteristics under conditions in which errors are included in elements of interference signals included in a reception signal.

### BRIEF DESCRIPTION OF THE DRAWINGS

FIG. 1 is a diagram illustrating a configuration of the entire communication system according to a first embodiment of the present invention.

FIG. 2 is a schematic block diagram illustrating a configuration of a first communication device 100 according to the first embodiment.

FIG. 3 is a schematic block diagram illustrating a configuration of a second communication device 400 according to the first embodiment.

FIG. 4 is a schematic block diagram illustrating a configuration of a third communication device 700 according to the first embodiment.

FIG. 5 is a diagram illustrating the relationship between a constellation of modulation symbols and δ when 16QAM is used as an example of modulation schemes.

FIG. 6 is a schematic block diagram illustrating an example of a configuration of a first communication device 100b according to a first modification.

FIG. 7 is a schematic block diagram illustrating an example of a configuration of a second communication device 400b according to the first modification.

FIG. 8 is a schematic block diagram illustrating an example of a configuration of a third communication device 700b according to the first modification.

FIG. 9 is a diagram illustrating a configuration of the entire communication system according to a second modification.

FIG. 10 is a schematic block diagram illustrating an example of a configuration of a first communication device 100c according to the second modification.

FIG. 11 is a schematic block diagram illustrating en example of a configuration of a second communication device 400c according to the second modification.

FIG. 12 is a schematic block diagram illustrating an example of a configuration of a first communication device 100d according to a third modification.

FIG. 13 is a schematic block diagram illustrating an example of a configuration of a second communication device 400d according to the third modification.

FIG. 14 is a schematic block diagram illustrating a configuration of a first communication device 101 according to a second embodiment of the present invention.

FIG. 15 is a schematic block diagram illustrating a configuration of a radio signal generator 324 according to the second embodiment.

FIG. 16 is a schematic block diagram illustrating a configuration of a second communication device 401 according to the second embodiment.

FIG. 17 is a diagram illustrating a flow of a signal when communication using inflated lattice precoding is performed.

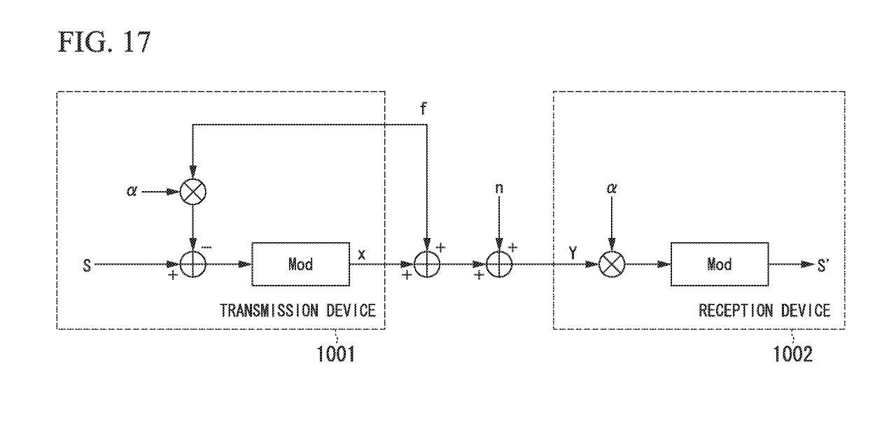

### BEST MODE FOR CARRYING OUT THE INVENTION

### First Embodiment

Hereinafter, embodiments of the present invention are explained with reference to drawings.

In the first embodiment, an embodiment is explained, in which when a first communication device 100 transmits a radio signal to a second communication device 400, and a radio signal transmitted by a third communication device using the same frequency as used by the first communication device becomes an interference signal with respect to a reception signal of the second communication device 400, the present invention is performed using channel state information CSI calculated by the second communication device 400. Here, the channel state information CSI includes complex gain indicated by a channel state.

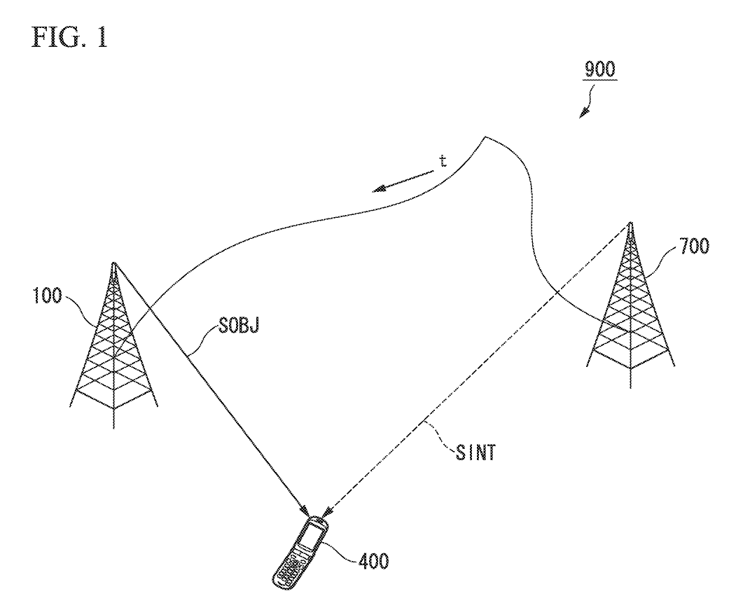

FIG. 1 is a diagram illustrating a configuration of the entire communication system according to the first embodiment.

In FIG. 1, a communication system 900 includes a first communication device 100, a second communication device 400, and a third communication device 700.

The first communication device 100 transmits a radio signal SOBJ to the second communication device 400. The second communication device 400 receives the radio signal SOBJ. A transmission scheme used by the first communication device 100 is OFDM (Orthogonal Frequency Division Multiplexing).

The first communication device 100 is, for example, a base station device in a mobile communication system. The second communication device 400 is, for example, a terminal station device in the mobile communication system.

The third communication device 700 transmits a radio signal with the same frequency as used by the first and second communication devices 100 and 400. A transmission signal transmitted by the third communication device 700 becomes an interference signal SINT with respect to the second communication device 400, and becomes an interference signal element included in a reception signal of the second communication device 400. Before performing transmission, the third communication device 700 gives notification of (transmits) a transmission signal t to the first communication device 100 through a wired line. The third communication device 700 may give the notification wirelessly.

The third communication device 700 is, for example, a base station device that performs communication in a cell different from that served by the first communication device 100. The third communication device 700 may be a relay station device that performs communication in the same cell as served by the first communication device 100, or another wireless communication device that transmits a wireless signal using the same frequency as used by the first communication device.

### (Configuration of First Communication Device)

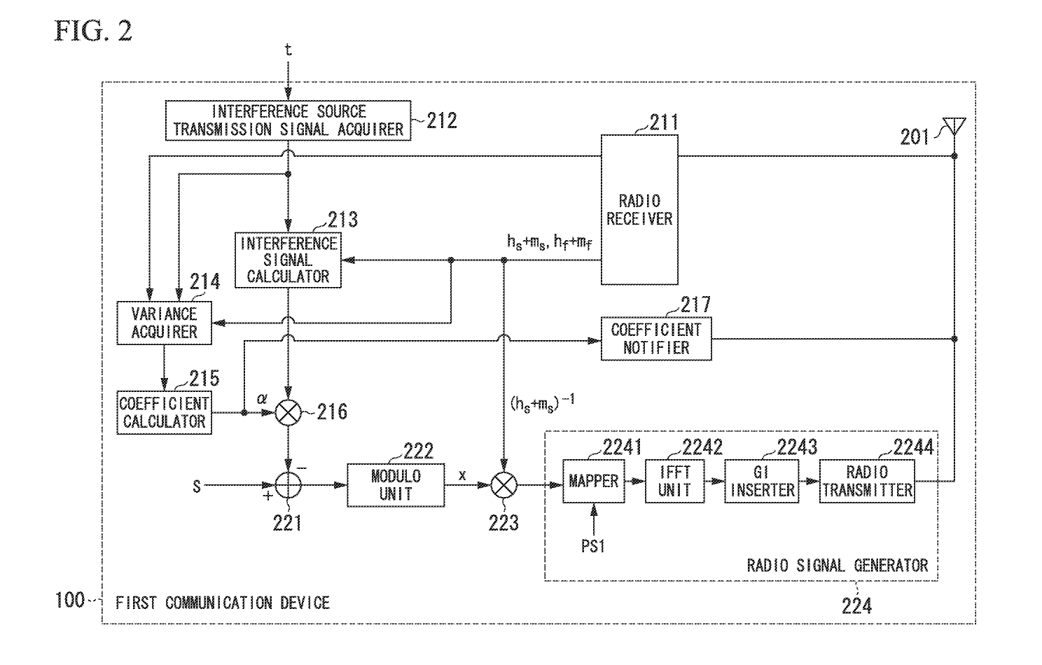

FIG. 2 is a schematic diagram illustrating a configuration of the first communication device 100 according to the first embodiment of the present invention.

In FIG. 2, the first communication device 100 includes: an antenna 201; a radio receiver 211; an interference source transmission signal acquirer 212; an interference signal calculator 213; a variance acquirer 214; a coefficient calculator 215; a coefficient multiplier 216; a coefficient notifier 217; an interference signal subtractor 221; a modulo unit 222; a channel divider 223; and a radio signal generator 224.

The radio signal generator 224 includes: a mapper 2241; an IFFT unit 2242; a GI inserter 2243; and a radio transmitter 2244.

The radio receiver 211 receives from the second communication device 400 through the antenna 201: channel state information of a channel from the first communication device 100 to the second communication device 400 (channel state information associated with a channel for a transmission signal); channel state information of a channel from the third communication device 700 to the second communication device 400 (channel state information associated with a channel for an interference signal); information concerning a variance of channel estimation errors that will be explained later; information concerning a variance of quantization errors; information concerning a variance of errors according to CSI transmission granularity (granularity of CSI in the frequency direction); information concerning a variance of errors due to a channel variation; and information concerning a variance of noise.

The interference source transmission signal acquirer 212 receives a transmission signal t of the third communication device 700, which is transmitted by the third communication device 700 through a wired line.

The interference signal calculator 213 calculates an estimation value of an interference signal element included in a reception signal of the second communication device 400 (hereinafter, referred to as an interference signal estimation value), based on: the transmission signal of the third communication device 700, which is received from the interference source transmission signal acquirer 212, that is, an interference signal of a transmission source; and channel state information of the channel from the third communication device 700 to the second communication device 400, which is received from the radio receiver 211, that is, channel state information associated with a channel for the interference signal.

The variance acquirer 214 receives from the radio receiver 211: a variance of channel estimation errors associated with a channel for a transmission signal that will be explained later; a variance of noise; a variance of errors according to CSI transmission granularity; and a variance of errors due to a channel variation.

The coefficient calculator 215 calculates a coefficient α based on the variances received from the variance acquirer 214. The details of a method of calculating the coefficient α will be explained later.

The coefficient multiplier 216 multiplies the interference signal estimation value received from the interference signal calculator 213 by the coefficient α received from the coefficient calculator 215 to calculate a signal to be subtracted from a desired signal s (subtraction signal). Here, a signal of which the first communication device finally notifies the second communication device 400 is referred to as a desired signal. The coefficient notifier 217 transmits the coefficient α received from the coefficient calculator 215 to the second communication device 400 through the antenna 201. Regarding transmission of the coefficient α, the coefficient α is preferably included in a control channel or the like for general OFDM transmission signals for which modulo arithmetic and the like are not performed, but the configuration is not limited thereto. Additionally, transmission of the coefficient α may be performed before or after transmission of the desired signal s. Further, the transmission of the coefficient α may be performed by wireless transmission other than OFDM transmission.

The interference signal subtractor 221 subtracts the subtraction signal received from the coefficient multiplier 216, from the desired signal s to be transmitted from the first communication device 100 to the second communication device 400. Thereby, the interference signal subtractor 221 previously cancels an interference signal to calculate a post-subtraction signal. Here, the signal s is a signal generated by: channel-coding data to be transmitted; and then modulating the coded data using a modulation scheme, such as QPSK (Quadrature Phase Shift Keying), 8PSK (8 Phase Shift Keying), 16QAM (16 Quadrature Amplitude Modulation), or 64QAM (64 Quadrature Amplitude Modulation).

The modulo unit 222 performs modulo arithmetic on the signal that has been subjected to the subtraction and received from the interference signal subtractor 221 (post-subtraction signal), that is, calculates a remainder by dividing the signal having been subjected to the subtraction by a predetermined value. Thus, the modulo unit 222 generates a power suppression transmission signal. The modulo arithmetic performed by the modulo unit 222 is the same as the arithmetic for suppressing an increase in transmission power, which is performed in the case of THP. The details thereof will be explained later.

The channel divider 223 divides the power suppression transmission signal received from the modulo unit 222 by complex gain indicated by a channel state of the transmission signal received from the radio receiver 211.

The radio signal generator 224 transmits the signal output from the channel divider 223, that is, a transmission signal based on the power suppression transmission signal.

The mapper 2241 of the radio signal generator 224 maps the signal that has been subjected to the division and received from the channel divider 223, and a pilot symbol PS1 to resource elements for OFDM symbols. Here, a resource element is a position on an OFDM transmission signal, and is defined as one segment obtained by dividing the OFDM transmission signal in units of OFDM symbols in the time direction and in units of subcarriers in the frequency direction. One modulation symbol is mapped to one of the resource elements.

The IFFT unit 2242 performs an IFFT process (Inverse Fast Fourier Transform) on the signal that has been subjected to the mapping process and received from the mapper 2241. Thus, the IFFT unit 2242 converts frequency domain signals into a time domain signal.

The GI inserter 2243 adds a guard interval GI (also referred to as a cyclic prefix CP) to the time domain signal received form the IFFT unit 2242.

The radio transmitter 2244 performs digital-to-analog conversion, frequency conversion, and the like, on the time domain signal with the guard interval added, which is received from the GI inserter 2243.

### (Configuration of Second Communication Device)

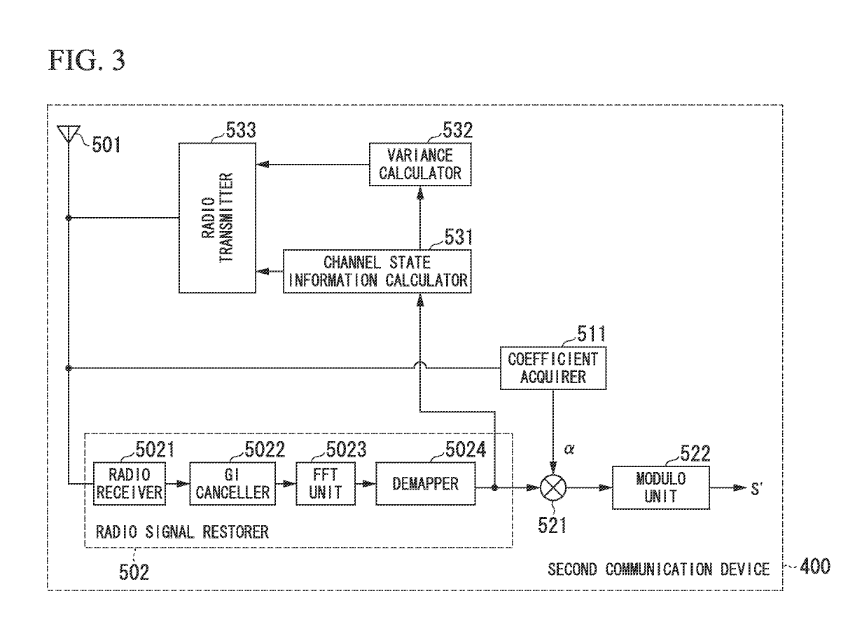

FIG. 3 is a schematic block diagram illustrating a configuration of the second communication device 400 according to the first embodiment of the present invention.

In FIG. 3, the second communication device 400 includes: an antenna 501; a radio signal restorer 502; a coefficient acquirer 511; a coefficient multiplier 521; a modulo unit 522; a channel state information calculator 531; a variance calculator 532; and a radio transmitter 533.

The radio signal restorer 502 includes: a radio receiver 5021; a GI canceller 5022; an FFT unit 5023; a demapper 5024.

The radio receiver 5021 performs frequency conversion, analog-to-digital conversion, and the like, on a radio signal transmitted from the first communication device 100 and a radio signal transmitted from the third communication device 700, which are received through the antenna 501.

The GI canceller 5022 cancels the guard interval from the signal received from the radio receiver 5021, that is, extracts an FFT (Fast Fourier Transform) section.

The FFT unit 5023 performs an FFT process with respect to the FFT section extracted by the GI canceller 5022 to convert the time domain signal into data symbols that are frequency domain signals.

The demapper 5024 previously obtains information concerning the mapping performed by the first communication device 100, and arranges, using the mapping information, the data symbols received from the FFT unit 5023 in the same order as that of the original data symbols (at the time of transmission). Additionally, the demapper 5024 extracts the pilot symbol PS1 using the mapping information, and outputs the extracted pilot symbol PS1 to the channel state information calculator 531. Similarly, the demapper 5024 extracts a pilot symbol PS3 transmitted from the third communication device 700, and outputs the extracted pilot symbol PS3 to the channel state information calculator 531.

The coefficient acquirer 511 receives, through the antenna 501, the coefficient α that is included in a control channel for the OFDM transmission signal and transmitted from the first communication device 100.

The coefficient multiplier 521 multiplies the data symbols received from the radio signal restorer 502 by the coefficient α received from the coefficient acquirer 511.

The modulo unit 522 performs, on the information data symbols that has been subjected to the multiplication and received from the coefficient multiplier 521, the same modulo arithmetic as performed by the modulo unit 222 of the first communication device 100 (shown in FIG. 2).

Using the pilot symbols PS1 and PS3 received from the radio signal restorer 502, the channel state information calculator 531 calculates channel state information of the channel from the first communication device 100 to the second communication device 400 (channel state information associated with the channel for the transmission signal), and channel state information of the channel from the third communication device 700 to the second communication device 400 (channel state information associated with the channel for the interference signal). The channel state information calculator 531 calculates an S/N (signal to noise) ratio of a reception signal and a delay spread of the reception signal that will be explained later, and outputs the S/N ratio and the delay spread to the variance calculator 532.

Using the S/N ratio of the reception signal and the delay spread of the reception signal which are received from the channel state information calculator 531, the variance calculator 532 calculates: information concerning a variance of channel estimation errors; information concerning a variance of errors according to CSI transmission granularity; information concerning a variance of errors due to a channel variation; and information concerning a variance of noise, which will be explained later.

The radio transmitter 533 transmits, to the first communication device 100 through the antenna 501: the channel state information of the channel from the first communication device 100 to the second communication device 400; the channel state information of the channel from the third communication device 700 to the second communication device 400; and the variances received from the variance calculator 532.

### (Configuration of Third Communication Device)

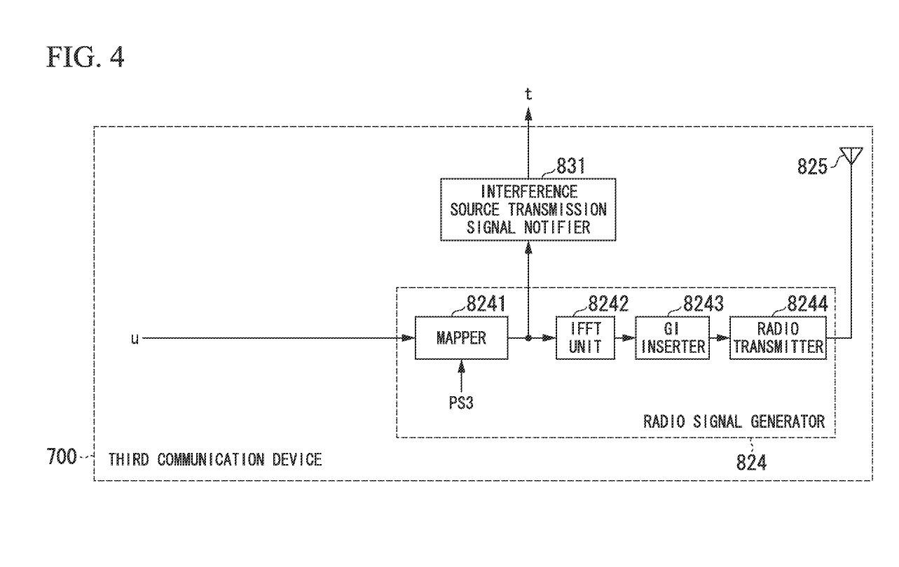

FIG. 4 is a schematic block diagram illustrating a configuration of the third communication device 700 according to the first embodiment of the present invention.

In FIG. 4, the third communication device 700 includes: a radio signal generator 824; an antenna 825; and an interference source transmission notifier 831.

The radio signal generator 824 includes: a mapper 8241; an IFFT unit 8242; a GI inserter 8243; and a radio transmitter 8244.

The mapper 8241 maps a signal u and a pilot symbol PS3 to be transmitted by the third communication device 700, to resource elements for OFDM symbols.

The IFFT unit 8242 performs an IFFT process on the signals that have been subjected to the mapping process and received from the mapper 8241, to convert the frequency domain signals into a time domain signal.

The GI inserter 8243 adds a guard interval to the time domain signal received from the IFFT unit 8242.

The radio transmitter 8244 performs digital-to-analog conversion, frequency conversion, and the like, on the time domain signal with the guard interval added, which is received from the GI inserter 8243. Then, the radio transmitter 8244 transmits the converted signal through the antenna 825.

The interference source transmission signal notifier 831 transmits the signals that have been subjected to the mapping process and received from the mapper 8241, as transmission signals of the third communication device 700, to the first communication device 100 through a wired line.

(Factors for Errors being Included in Channel State Information Csi)

Hereinafter, factors for errors being included in channel state information CSI obtained by the first communication device 100 are explained.

An actual channel from the first communication device 100 to the second communication device 40 is denoted as hₛ. An actual channel from the third communication device 700 to the second communication device 400 is denoted as h_{f}. Because of factors that will be explained below, it is substantially impossible for the first communication device 100 to recognize hₛ and h_{f} as channel state information CSI without any errors. Hereinafter, channel state information CSI of the channel from the first communication device 100 to the second communication device 400, which is obtained by the first communication device 100, is denoted as hₛ′=hₛ+mₛ. Channel state information CSI of the channel from the third communication device 700 to the second communication device 400, which is obtained by the first communication device 100, is denoted as h_{f}′=h_{f}+m_{f}. mₛ and m_{f} are errors included in hₛ′ and h_{f}′ that are channel state information pieces CSI obtained by the first communication device 100, respectively.

The channels hₛ and h_{f} are channel characteristics of orthogonal OFDM channels (subcarriers). A transmission scheme used by the first communication device may be 1-DM (Frequency Division Multiplexing). In this case, the channels hₛ and h_{f} are also the characteristics of the respective channels.

Factors for errors being included in the channel state information CSI obtained by the first communication device 100 differ according to a method for the first communication device 100 to recognize the channel state information CSI, and reasons that an interferences signal occurs.

In the first embodiment, a method of recognizing channel state information CSI is a method for the second communication device 400 to calculate the channel state information CSI, quantize the calculated channel state information CSI, and transmit the channel state information CSI as a digital signal. As explained above, the reason that an interference signal occurs is that a transmission signal of the third communication device 700 becomes an interference signal. Hereinafter, a method for the second communication device 400 to calculate channel state information CSI to recognize the channel state information CSI, quantize the calculated channel state information, and transmit the channel state information as a digital signal is referred to as a first method.

As a first factor for errors being included in channel state information CSI, it can be considered that channel estimation errors occur due to the intrusion of noise, temporal shadowing (shadowing a channel by a shadowing substance), or the like when the second communication device 400 calculates channel state information according to pilot signals transmitted from the first communication device 100 and the third communication device 700, that is, when performing channel estimation.

As a second factor, it can be considered that quantization errors are generated by quantization when the second communication device 400 transmits the estimated channel state information CSI as a digital signal to the first communication device 100.

As a third factor, it can be considered that errors according to a width in the frequency direction (granularity) occur due to the second communication device 400 compiling channel information with a width in the frequency direction into one value though a state of the channel differs in the frequency direction, and transmitting the value as the channel state information CSI to the first communication device 100.

As a fourth factor, it can be considered that errors occur due to a variation of the channel caused by the second communication device 400 moving while the first communication device 100 performs transmission.

### (Method of Acquiring Variance of Errors Included in Channel State Information Csi)

As explained above, errors are included in the channel state information CSI acquired by the first communication device 100. For this reason, the variance acquirer 214 of the first communication device 100 acquires a variance of errors included in the channel state information CSI, and the coefficient calculator 215 calculates the coefficient α in consideration of the variance of the errors included in the channel state information CSI. Hereinafter, a method for the variance acquirer 214 to acquire a variance of errors included in the channel state information CSI is explained.

Hereinafter, a method of calculating a variance of errors occurring due to the aforementioned factors is explained first.

The channel estimation errors due to the first factor are affected by noise included in a reception signal of the second communication device 400. For this reason, for example, a function of a variance of channel estimation errors, where the S/N ratio is a parameter, is previously calculated using a simulation, such as Monte Carlo simulation, and the variance calculator 532 of the second communication device 400 stores the function. Then, the channel state information calculator 531 calculates the S/N ratio of a reception signal and outputs the calculated S/N ratio to the variance calculator 532. The variance calculator 532 substitutes the input S/N ratio in the function, and thereby calculates a variance of the channel estimation errors.

The quantization errors due to the second factor depend on a quantization method. For this reason, a variance of quantization errors is previously calculated based on a method of digitalization performed by the second communication device 400, and the variance calculator 532 of the second communication device stores the calculated variance.

The errors according to the CSI transmission granularity, which are errors due to the third factor, are affected by the granularity for the second communication device 400 to transmit channel state information CSI, and a delay spread of the reception signal of the second communication device 400.

For this reason, for example, a function of a variance of the errors due to the third factor, where the granularity and the delay spread are parameters, is previously calculated using a simulation, such as Monte Carlo simulation, and the variance calculator 532 of the second communication device 400 stores the function. Then, the channel state information calculator 531 calculates a delay spread of the reception signal and outputs the calculated delay spread to the variance calculator 532. The variance calculator 532 substitutes, in the function, the input delay spread and the granularity when the second communication device 400 transmits the channel state information CSI, and thereby calculates a variance of errors according to the CSI transmission granularity.

Here, the delay spread is a standard variation indicating the degree of spread of the delay profile (average reception power when a delay time is a parameter). Using delay profile Pₙ (where n is the sampling number) obtained by sampling with the sampling interval T, the channel state information calculator 531 can calculate the delay spread based on the following expression (3).

$$\begin{matrix}( Expression 3 ) & \\ S = \sqrt{\frac{{\sum }_{n} {( n T - d )}^{2} \cdot {P}_{n}}{{\sum }_{n} {P}_{n}}} & Expression ( 3 )\end{matrix}$$

where d denotes an average value of Pₙ, and

$${\sum }_{n}$$

denotes, for example, a sum of sampling numbers within a time corresponding to the OFDM length.

The errors due to the fourth factor are errors due to a time variation of a channel. Specifically, the errors are errors due to the degree of a channel variation for RTT (Round Trip Time). RTT indicates a time during which the following processes are performed. The second communication device 400 performs channel estimation and notifies the first communication device of the channel state information. Using the channel state information, the first communication device transmits a signal by a transmission method based on the present invention. The second communication device receives the signal. The time required for performing the above processes is the RTT. For this reason, for example, the variance calculator 532 calculates a variance of the errors due to the fourth factor, based on the time variation of the channel state information received from the channel state information calculator 531.

A variance of errors in channel state information CSI is calculated by calculating a sum of part of or all of the errors due to each of the aforementioned factors. For example, the variance calculator 532 of the second communication device 400 transmits a variance of errors due to each factor to the first communication device 100 through the radio transmitter 533 and the like, and the variance acquirer 214 calculates a sum of the transmitted variances, thereby calculating the variance of errors in the channel state information CSI.

In other words, the variance acquirer 214 acquires a variance of channel estimation errors associated with the channel for the interference signal, and regards the acquired variation as a variance of errors in channel state information associated with the channel for the interference signal. Alternatively, the variance acquirer 214 acquires, in addition to the variance of the channel estimation errors associated with the channel for the interference signal, at least one of a variance of errors according to the granularity for transmitting the channel state information, a variance of errors due to a channel variation associated with the channel for the interference signal, and a variance of quantization errors in the channel state information associated with the channel for the interference signal. Then, the variance acquirer 214 calculates a sum of these variances, thereby calculating a variance of errors in the channel state information associated with the channel for the interference signal.

Additionally, the variance acquirer 214 acquires a variance of channel estimation errors associated with the channel for the transmission signal, and regards the acquired variation as a variance of errors in channel state information associated with the channel for the transmission signal. Alternatively, the variance acquirer 214 acquires, in addition to the variance of the channel estimation errors associated with the channel for the transmission signal, at least one of a variance of errors according to the granularity for transmitting the channel state information, a variance of errors due to a channel variation associated with the channel for the transmission signal, and a variance of quantization errors in the channel state information associated with the channel for the transmission signal. Then, the variance acquirer 214 calculates a sum of these variances, thereby calculating a variance of errors in the channel state information associated with the channel for the transmission signal.

Alternatively, after the variance calculator 532 calculates a sum of variances with respect to part of the factors and transmits the calculated sum to the variance acquirer 214, the variance acquirer 214 may finally calculate a sum of errors due to all the factors.

Alternatively, after the variance calculator 532 calculates a sum of variances with respect to all the factors and notifies the variance acquirer 214 of the calculated sum, the variance acquirer 214 may calculate a sum of errors due to all the factors.

### (Timing of Transmitting Variances of Errors Due to Each Factor)

Regarding the variance of channel estimation errors due to the first factor, the precision of channel estimation varies depending on the channel estimation method used by the second communication device 400. For this reason, when the variance calculator 532 initiates transmission using the present method, the variance calculator 532 of the second communication device 400 calculates a variance of errors by the aforementioned method and transmits the calculated variance to the first communication device 100. Additionally, since channel estimation errors vary also when the average reception power varies by a predetermined value or more due to shadowing and the like, the calculated variance is transmitted to the first communication device 100 again. In other words, the channel state information calculator 531 of the second communication device 400 calculates the average reception power of a reception signal. When communication is initiated or when the average reception power of the reception signal varies by a predetermined value or more, the variance calculator 532 calculates a variance of channel estimation errors associated with the channel for the interference signal which occur when calculating channel state information associated with the channel for the interference signal, and a variance of channel estimation errors associated with the channel for the transmission signal which occur when calculating channel state information associated with the channel for the transmission signal.

After the variances are calculated in the above timing, the radio transmitter 533 transmits the variance of the channel estimation errors associated with the channel for the interference signal and the variance of the channel estimation errors associated with the channel for the transmission signal.

Instead of calculating and transmitting a variance of channel estimation errors when the average reception power varies by a predetermined value or more, the variance of the channel estimation errors may be periodically transmitted after a predetermined period of time elapses, or only when communication is initiated.

The variance of errors in channel state information CSI due to the second factor can be calculated using a constant value determined according to a quantization method, and therefore can be acquired by the first communication device 100. For this reason, it is not always necessary for the second communication device 400 to transmit the variance of errors in channel state information CSI. In other words, based on the method of transmitting channel state information associated with the channel for the interference signal, the variance acquirer 214 generates a variance of quantization errors in the channel state information associated with the channel for the interference signal. Additionally, based on the method of transmitting the channel state information associated with the channel for the transmission signal, the variance acquirer 214 generates a variance of quantization errors in the channel state information associated with the channel for the transmission signal.

The variance of errors due to the third factor is affected by the granularity and the delay spread as explained above. For this reason, the variance calculator 532 of the second communication device 400 transmits the variance of errors due to the third factor to the first communication device 100 when communication is commenced, when the granularity for transmitting the channel state information CSI is changed, and when the delay spread varies by a predetermined value or more. In other words, the radio receiver 5021 of the second communication device 400 calculates a delay spread of a reception signal. When communication is commenced and when the delay spread varies by the predetermined value or more, the variance calculator 532 calculates errors according to the granularity for transmitting channel state information associated with the channel for the interference signal, and errors according to the granularity for transmitting channel state information associated with the channel for the transmission signal.

The timing of calculating and transmitting a variance of errors according to the granularity is not limited thereto, and the variance of errors may be periodically transmitted after a predetermined period of time elapses. Alternatively, the variance of errors may be transmitted only when communication is commenced.

The radio transmitter 533 transmits the errors according to the granularity for transmitting the channel state information associated with the channel for the interference signal, and the errors according to the granularity for transmitting the channel state information associated with the channel for the transmission signal.

A variance of errors due to the fourth factor depends on a moving speed of the second communication device 400 which is measured by the second communication device 400, or f_{d} (the maximum Doppler frequency). For this reason, the variance of errors due to the fourth factor is notified of when the moving speed of the second communication device 400 or f_{d} varies by a predetermined value or more, as well as when communication is commenced by the present method. In other words, the channel state information calculator 531 calculates the maximum Doppler frequency of a reception signal. The variance calculator 532 calculates a variance of channel variation errors associated with the channel for the interference signal and a variance of channel variation errors associated with the channel for the transmission signal when communication is commenced and when the maximum Doppler frequency of the reception signal varies by the predetermined value or more.

The channel state information calculator 531 transmits the variance of the channel variation errors associated with the channel for the interference signal and the variance of the channel variation errors associated with the channel for the transmission signal.

The timing of calculating and transmitting a variance of errors due to channel variation is not limited thereto. The variance of errors may be periodically transmitted after a predetermined period of time elapses. Alternatively, the variance of errors may be transmitted only when communication is commenced.

### (Variance Acquired by Variance Acquirer)

The variance acquirer 214 of the first communication device 100 calculates, by the aforementioned method, a variance σₘₛ² of errors in channel state information CSI related to the channel from the first communication device 100 to the second communication device 400 (including all the error factors), and a variance σ_{mf}² of errors in channel state information CSI related to the channel from the third communication device 700 to the second communication device 400 (including all the error factors). Additionally, the variance acquirer 214 acquires a variance σₓ² of the transmission signal and a variance σₜ² of the interference signal. Additionally, the variance acquirer 214 calculates, using these variances, a variance σₘ² of errors included in an interference element according to imperfection of the channel state information CSI. In other words, the variance acquirer 214 calculates a variance σₘ² of errors included in the interference element by using the variance σₘₛ² of errors in channel state information CSI associated with the channel for the transmission signal, the variance σ_{mf}² of errors in channel state information CSI associated with the channel for the interference signal, the variance σₓ² of the transmission signal, and the variance σₜ² of the interference signal. A method of calculating the variance σₘ² will be explained later. Additionally, the variance acquirer 214 outputs, to the coefficient calculator 215, a variance σₙ² of noise, the variance σₓ² of the transmission signals, and the variance σₜ² of errors in the interference signal.

The variance σₙ² of noise is generated by, for example, in the following manner. With use of the fact that noise is random and an average value thereof is 0, multiple pilot signals generated in the time direction from the same pattern are received. Then, an average value of the received pilot signals is calculated, thereby cancelling the noise elements by averaging. Then, the average value is subtracted from each of the received pilot signals, thereby extracting noise added to each of the pilot signals. Then, a variance of the noise is calculated, thereby generating the variance σₙ² of the noise.

Additionally, as the variance σₓ² of the transmission signals, for example, the variance acquirer 214 previously stores a value defined based on a method of communication performed by the first communication device, and this value is used. In other words, the variance acquirer 214 generates the variance σₓ² of the transmission signals based on the method of communication performed by the first communication device.

Similarly, as the variance σₜ² of the interference signals, for example, the variance acquirer 214 previously stores a value defined based on a method of communication performed by the third communication device, and this value is used.

The coefficient calculator 215 calculates the coefficient α using the variance σₙ² of noise, the variance σₓ² of the transmission signals, and the variance σₘ² of the interference signals, which are received from the variance acquirer 214, as will be explained later.

When the coefficient calculator 215 outputs the variances to the variance acquirer 214, the values of the variances are expressed by the unit of dBm. In this case, only a ratio of the variances may be output. Alternatively, the values of the variances may be expressed by another unit.

### (Improvement of Error Rate Characteristics Using Variance of Errors in Channel State Information CSI)

Hereinafter, a method of improving the error rate of reception signals using the variance of errors in channel state information CSI is explained.

A desired signal to be transmitted from the first communication device 100 to the second communication device 400 is defined as s. An estimation value of s, which is estimated by the second communication device 400, is defined as s′.

As explained above, errors mₛ and m_{f} are included in hₛ′=hₛ+m, and h_{f}′=h_{f}+m_{f}, respectively, which are channel state information pieces CSI of which the first communication device 100 notifies the second communication device 400. In other words, the errors mₛ and m_{f} are errors indicating imperfections in the channel state information pieces CSI. Hereinafter, a variance of mₛ is defined as σₘₛ and a variance of m_{f} is defined as σ_{mf}.

Additionally, a transmission signal of the third communication device 700 is defined as t. In the first embodiment, the third communication device 700 previously transmits the transmission signal t to the first communication device 100 through a wired line.

An interference signal f received by the second communication device 400 is f=h_{f}t. The interference signal calculator 213 of the first communication device 100 calculates, using h_{f}′ that is channel state information CSI including errors, an interference signal estimation value as h_{f}′t=h_{f}t+m_{f}t. In other words, the interference signal calculator 213 acquires the interference signal t for an interference source, and channel state information h_{f}′ associated with the channel for the interference signal. Then, the interference signal calculator 213 calculates the interference signal estimation value h_{f}′t based on the interference signal t for the interference source and the channel state information h_{f}′ associated with the channel for the interference signal. The interference signal calculator 213 outputs the calculated interference signal estimation value h_{f}′t to the coefficient multiplier 216.

The coefficient multiplier 216 multiplies the interference signal estimation value h_{f}′t output from the interference signal calculator 213 by the coefficient α output from the coefficient calculator 215, thereby calculating a subtraction signal. The coefficient calculator 215 outputs the calculated subtraction signal to the interference signal subtractor 221.

The interference signal subtractor 221 subtracts the subtraction signal αh_{f}′t from the desired signal s to be transmitted, thereby calculating a post-subtraction signal v=s−αh_{f}′t. The interference signal subtractor 221 outputs the calculated post-subtraction signal v to the modulo unit 222.

The modulo unit 222 performs, on the input post-subtraction signal v, a modulo arithmetic as in the expression (4). In other words, the modulo unit 222 divides the post-subtraction signal by a predetermined value to obtain a remainder, thereby calculating a power suppression transmission signal M(v).

$$\begin{matrix}( Expression 4 ) & \\ M ( v ) = v - ⌊ \frac{Re ( v )}{δ} + \frac{1}{2} ] \cdot δ - ⌊ \frac{Im ( v )}{δ} + \frac{1}{2} ⌋ \cdot δ \cdot i & Expression ( 4 )\end{matrix}$$

where

$$⌊ \frac{Re ( v )}{δ} + \frac{1}{2} ⌋$$

denotes the maximum integer not exceeding

$$\frac{Re ( v )}{δ} + \frac{1}{2} ,$$

Re(v) denotes a real part, Im(v) denotes an imaginary part, and i denotes an imaginary unit.

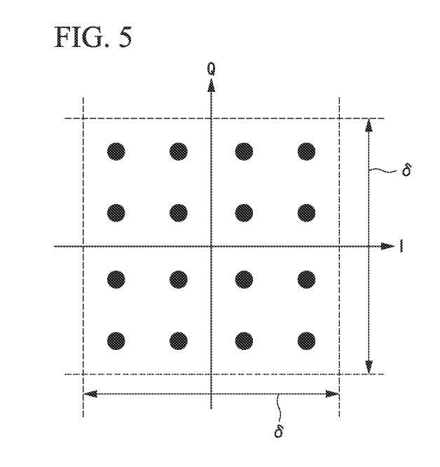

Here, δ is a predetermined value indicating a width determined as including all constellations (positions of signal points) defined according to a method of modulating s. Hereinafter, δ is explained with reference to FIG. 5. FIG. 5 is a diagram illustrating the relationship between δ and constellations of modulation symbols when 16QAM is used as a modulation method. As shown in FIG. 5, a value of δ is defined so that all the constellations of the modulation symbols are included in the range of −δ/2 to δ/2, and −iδ/2 to iδ/2 (where i is an imaginary unit).

For example, it can be determined such that δ=2\sqrt{2} when the modulation method is QPSK, δ=8\sqrt{10} when the modulation method is 16QAM, and δ=16\sqrt{42} when the modulation method is 64QAM. A value of δ is not limited to the above value as long as both the first and second communication device 100 and 400 know the value, and the value is greater than the width of the constellations of modulation symbols.

Hereinafter, the power suppression transmission signal M(v) output from the modulo unit 222 is denoted as x.

The channel divider 223 divides the power suppression transmission signal x received from the modulo unit by the channel state information hₛ′=hₛ+mₛ. In other words, the channel divider 223 multiplies the inverse characteristics of the channel for the transmission signal, thereby performing a pre-equalization process. The channel divider 223 outputs hₛ′⁻¹x as a result of the division to the radio signal generator 224.

The radio signal generator 224 transmits the hₛ′⁻¹x received from the channel divider 223 to the second communication device 400 by means of OFDM. In other words, the radio signal generator 224 transmits a transmission signal based on the power suppression transmission signal x.

On the other hand, a signal y output from the demapper 5024 of the second communication device 400 is affected by channel characteristics hₛ, an interference signal f, and a noise n, and can be expressed as in the expression (5).

$$\begin{matrix}( Expression 5 ) & \\ \begin{matrix}y = {h}_{s} {h}_{s}^{′ - 1} x + f + n \\ = ( {h}_{s}^{′} - {m}_{s} ) {h}_{s}^{′ - 1} x + f + n \\ = x - {m}_{s} {h}_{s}^{′ - 1} x + f + n\end{matrix} & Expression ( 5 )\end{matrix}$$

The coefficient multiplier 521 multiplies y received from the demapper 5024 by the coefficient α, and outputs αy to the modulo unit 522. The modulo unit 522 performs, on αy received from the coefficient multiplier, a modulo arithmetic similar to that performed by the modulo unit 222 of the first communication device 100. An output from the modulo unit 522 is s′, that is, an estimation value of the second communication device 400 with respect to s.

Hereinafter, a variance of differences between s and s′ is explained.

Firstly, M(s′-s) can be calculated as in the expression (6), where it is assumed that the difference between s and s′ does not exceed δ.

$$\begin{matrix}( Expression 6 ) & \\ \begin{matrix}\tilde{s} = M ( α y ) \\ = M ( α ( x - {m}_{s} {h}_{s}^{′ - 1} x + f + n ) )\end{matrix} \\ \begin{matrix}M ( \tilde{s} - s ) = M ( α ( x - {m}_{s} {h}_{s}^{′ - 1} x + f + n ) - s ) \\ = M ( α ( x - {m}_{s} {h}_{s}^{′ - 1} x + {h}_{f} t + n ) - x - α {h}_{f}^{′} t ) \\ = M ( α n - ( 1 - α ) x - α {m}_{f} t - α {m}_{s} {h}_{s}^{′ - 1} x )\end{matrix} & Expression ( 6 )\end{matrix}$$

Then, a mean square of the difference between s and s′, that is, a variance, is calculated as in the expression (7).

(Expression 7)

E[∥\tilde{s}−s∥²]=α²σₙ²+(1−α)²σₓ²+α²σ_{mf}²σₜ²+α²h′ₛ⁻²σₘₛ²σₓ² Expression (7)

Here, the fact that a variance V[XY], which is a product of independent random variables X and Y, an average of which is zero, is identical to a product V[X]V[Y] of variances of the respective random variables, is used.

The two right terms indicate an increase in the error rate due to errors in a reception signal, which is caused by errors included in channel state information CSI. Accordingly, a variance of errors in an interference signal according to imperfection of the channel state information CSI can be expressed as in the expression (8).

(Expression 8)

σₘ²=σ_{mf}²σₜ²+h′ₛ⁻²σₘₛ²σₓ² Expression (8)

According to this expression, the variance acquirer 214 of the first communication device 100 calculates σₘ² from σₘₛ², σ_{mf}², σₓ², σₜ², and complex gain hₛ′ indicated by a channel state. In other words, the variance acquirer 214 acquirers the variance σₜ² of interference signals, which is calculated from interference signals for an interference source, and acquires complex gain (channel state information) hₛ′ indicated by a channel state associated with the channel for the transmission signal. Then, the variance acquirer 214 calculates a sum of a product of the variance σ_{mf}² of errors in the complex gain indicated by the channel state associated with the channel for the interference signal and the variance σ_{f}² of the interference signal, and a value obtained by dividing, by a square of the complex gain hₛ′ indicated by the channel state associated with the channel for the transmission signal, a product of the variance σₘₛ² of errors in the complex gain indicated by the channel state associated with the channel for the transmission signal and the variance σₓ² of the transmission signal. Thereby, the variance acquirer 214 calculates the variance σₘ² of errors in an interference element.

The variance acquirer 214 may acquire (calculate in the case of first embodiment) only one of the variance σ_{mf}² of the channel estimation errors associated with the channel for the interference signal and the variance σₘₛ² of the channel estimation errors associated with the channel for the transmission signal, and calculate the variance σₘ² of interference elements. In other words, the variance acquirer 214 may calculate σₘ² based on the expression of σₘ²=σ_{mf}²σₜ² or the expression of σₘ²=hₛ′⁻²σₘₛ²σₓ².

The variance acquirer 214 calculates σₘ² using only one of σₘₛ² and σ_{mf}², thereby reducing an amount of calculation performed by the variance acquirer 214. On the other hand, the variance acquirer 214 calculates σₘ² using both σₘₛ² and σ_{mf}², thereby acquiring σₘ² with higher precision.

The coefficient calculator 215 calculates the coefficient α using σₓ², σₙ², and σₘ². σₘ² is calculated using the variance of the channel estimation errors associated with the channel for the transmission signal and the variance of the channel estimation errors associated with the channel for the interference signal. Accordingly, the coefficient calculator 215 calculates the coefficient α using the variance of the channel estimation errors associated with the channel for the transmission signal, the variance of the channel estimation errors associated with the channel for the interference signal, and the variance of noise.

Here, as explained above, a mean square of the difference between s and s′ can be expressed by a quadratic function of α as shown in the expression (9).

$$\begin{matrix}[ Expression 9 ] & \\ \begin{matrix}E [ {‖ \tilde{s} - s ‖}^{2} ] = {α}^{2} {σ}_{n}^{2} + {( 1 - α )}^{2} {σ}_{x}^{2} + {α}^{2} {σ}_{m}^{2} \\ = ( {σ}_{n}^{2} + {σ}_{m}^{2} + {σ}_{x}^{2} ) \\ {\{ α - \frac{{σ}_{x}^{2}}{{σ}_{n}^{2} + {σ}_{m}^{2} + {σ}_{x}^{2}} \}}^{2} + \\ \frac{{σ}_{x}^{2} ( {σ}_{n}^{2} + {σ}_{m}^{2} )}{{σ}_{n}^{2} + {σ}_{m}^{2} + {σ}_{x}^{2}}\end{matrix} & Expression ( 9 )\end{matrix}$$

α that makes this the minimum can be expressed as the expression (10). The coefficient calculator 215 calculates this α. In other words, the coefficient calculator 215 divides the variance of transmission signals by a sum of the variance of the transmission signals, the variance of the interference signals, and the variance of the noise, thereby calculating the coefficient α.

$$\begin{matrix}[ Expression 10 ] & \\ α = \frac{{σ}_{x}^{2}}{{σ}_{n}^{2} + {σ}_{m}^{2} + {σ}_{x}^{2}} & Expression ( 10 )\end{matrix}$$

In this case, the mean square of the difference between s and s′ becomes σₓ²(σₙ²+σₘ²)/(σₙ²+σₘ²+σₓ²).

Since σₓ²>0, σₙ²>0, σₘ²>0, a value of σₓ²(σₙ²+σₘ²)/(σₙ²+σₘ²+σₓ²) is smaller than a value of σₙ²+σₘ² when THP is simply used (corresponding to the case of α=1) and a value of σₓ²(σₙ²+σₘ²)/(σₙ²+σₓ²) when α=σₓ²(σₙ²+σₓ²) in the case of the inflated lattice precoding.

Accordingly, the error rate characteristics are improved.

### (First Modification)

Hereinafter, a first modification of the first embodiment is explained.

In the first embodiment, the case has been explained, in which the method of recognizing channel state information CSI is the method for the second communication device 400 to calculate the channel state information CSI, quantize the calculated channel state information CSI, and transmit the channel state information CSI as a digital signal, and the reason that an interference signal occurs is that a transmission signal from the third communication device 700 becomes the interference signal. On the other hand, when a channel is reversible, such as when the same frequency is used between an uplink and a downlink, with use of the reversibility of the channel, a first communication device 100b and a second communication device 700b may calculate channel state information CSI using a pilot signal transmitted from a second communication device 400b.

In the first modification, a case is explained, in which a method of recognizing channel state information CSI is a method for the first communication device 100b and the third communication device 700b to perform channel estimation using the pilot signal transmitted from the second communication device 400b, and the reason that an interference signal occurs is that a transmission signal transmitted from the third communication device 700b becomes the interference signal.

### (Configuration of First Communication Device)

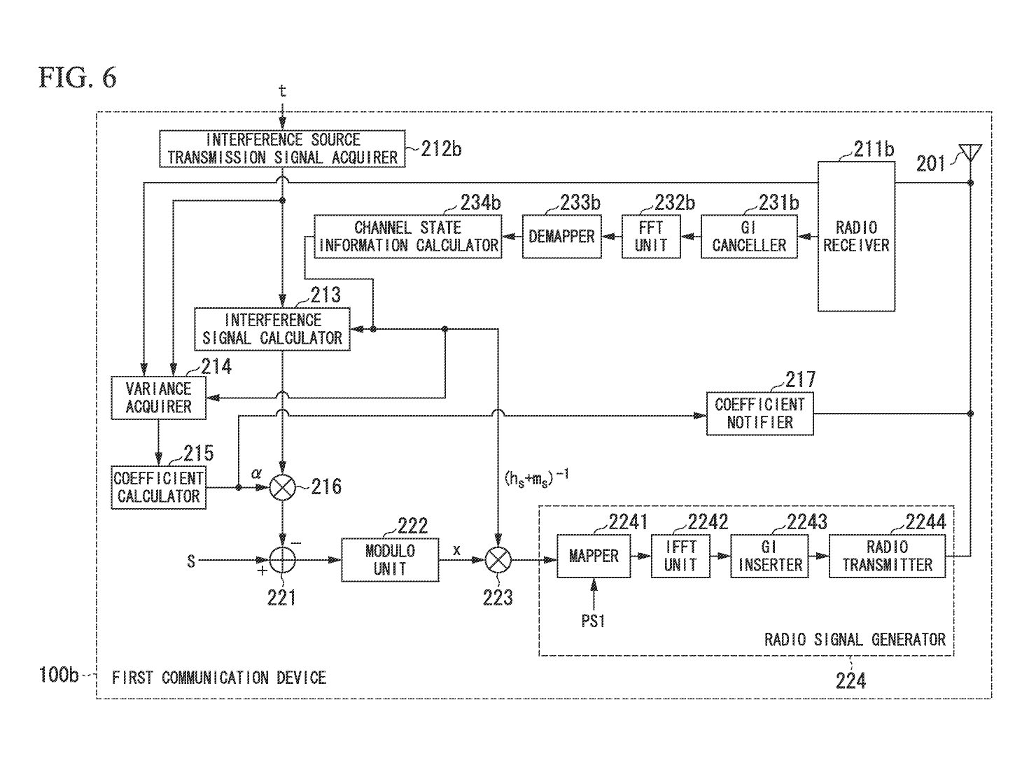

FIG. 6 is a schematic block diagram illustrating a configuration of the first communication device 100b according to the first modification.

In FIG. 6, the same reference numerals (201, 213, 214, 215, 216, 217, 221, 222, 223, 224, 2241, 2242, 2243, and 2244) are appended to units corresponding to those shown in FIG. 2, and explanations thereof are omitted here.

The first communication device 100b shown in FIG. 6 differs from the first communication device 100 shown in FIG. 2 in that the first communication device 100b is configured to include a GI canceller 231b, an FFT unit 232b, a demapper 233b, and a channel state information calculator 234b.

The radio receiver 211b receives a pilot signal and variances that will be explained later from the second communication device 400b through the antenna 201.

The GI canceller 231b removes a guard interval from the signal received from the radio receiver 211b, in other words, extracts an FFT section.

The FFT unit 232b performs an FFT process with respect to the FFT section extracted by the GI canceller 231b to convert a time domain signal into data symbols that are frequency domain signals.

The demapper 233b extracts a pilot symbol PS2 from the data symbols received from the FFT unit 232b, and outputs the extracted pilot symbol PS2 to the channel state information calculator 234b.

The channel state information calculator 234b calculates channel state information of a channel from the second communication device 400b to the first communication device 100b by using the pilot signal PS2 received form the demapper 233b.

The interference source transmission signal acquirer 212b receives a transmission signal t of the third communication device 700b and channel state information h_{f}+m_{f} of a channel from the second communication device 400b to the third communication device 700b, which are transmitted from the third communication device 700b through a wired line.

The radio signal generator 224 includes the mapper 2241, the IFFT unit 2242, the GI inserter 2243, and the radio transmitter 2244.

The mapper 2241 is similar to the mapper 2241 shown in FIG. 2.

The IFFT unit 2242, the GI inserter 2243, and the radio transmitter 2244 are similar to those shown in FIG. 2, and explanations thereof are omitted here.

### (Configuration of Second Communication Device)

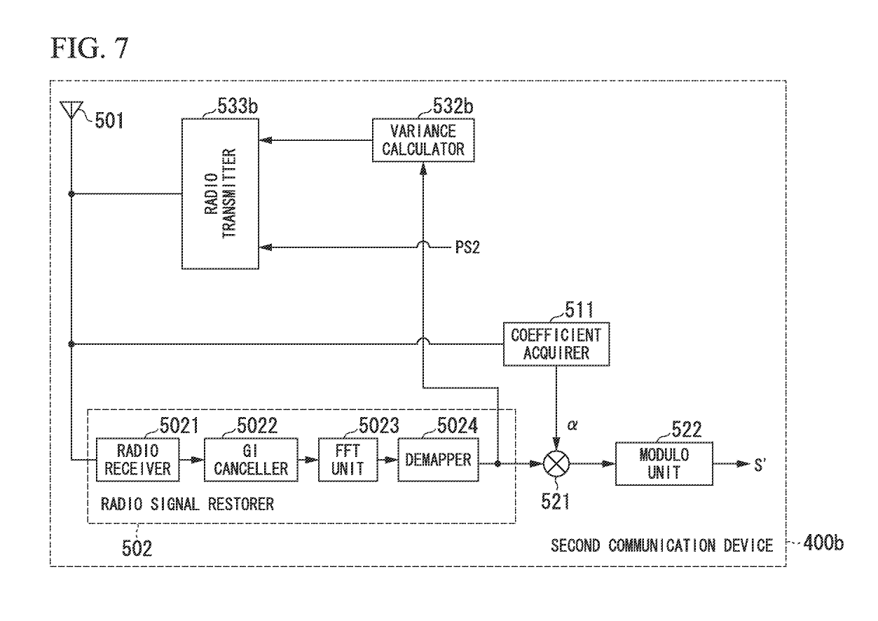

FIG. 7 is a schematic block diagram illustrating an example of a configuration of the second communication device 400b according to the first modification.

In FIG. 7, the same reference numerals (501, 502, 5021, 5022, 5023, 5024, 511, 521, and 522) are appended to units corresponding to those shown in FIG. 3, and explanations thereof are omitted here.

The second communication device 400b shown in FIG. 7 differs from the second communication device 400 shown in FIG. 3 in that the second communication device 400b does not include the channel state information calculator 531, that a variation calculator 532b receives a signal output from the radio signal restorer 502, and that a radio transmitter 533b receives the pilot symbol PS2, not a signal output from the channel state information calculator 531.

The variance calculator 532b calculates an S/N (signal to noise) ratio of a reception signal and a delay spread of the reception signal by using the pilot symbol received from the radio signal restorer 502. The variance calculator 532b calculates, using the calculated S/N ratio of the reception signal and the delay spread of the reception signal, information concerning a variance of channel estimation errors, information concerning a variance of errors according to the CSI transmission granularity, information concerning a variance of errors due to channel variation, and information concerning a variance of noise, which will explained later.

The radio transmitter 533b transmits the variances received from the variance calculator 532b and the pilot symbol PS2 to the first communication device 100b through the antenna 501.

### (Configuration of Third Communication Device)

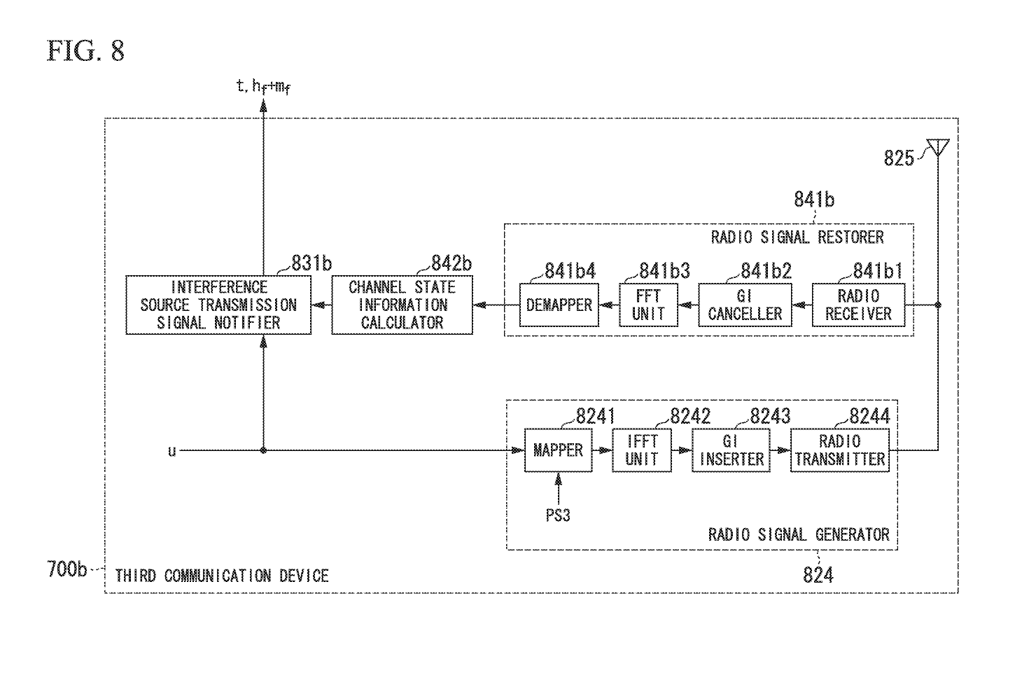

FIG. 8 is a schematic block diagram illustrating an example of a configuration of the third communication device 700b according to the first modification.

In FIG. 8, the same reference numerals (824, 8241, 8242, 8243, 8344, and 825) are appended to units corresponding to those shown in FIG. 4, and explanations thereof are omitted here.

The third communication device 700b shown in FIG. 8 differs from the third communication device 700 shown in FIG. 4 in that the third communication device 700b is configured to include a radio signal restorer 841b and a channel state information calculator 842b, and that an interference source transmission signal notifier 831b receives a signal from the channel state information calculator 542b.

The radio signal restorer 841b is configured to include: a radio receiver 841b1; a GI canceller 841b2; an FFT unit 841b3; and a demapper 841b4.

The radio receiver 841b2 performs a process, such as frequency conversion and analog-to-digital conversion, on a radio signal received from the second communication device 400b through the antenna 825.

The GI canceller 841b2 removes a guard interval from the signal received from the radio receiver 841b1, in other words, extracts an FFT section.

The FFT unit 841b3 performs an FFT process with respect to the FFT section extracted by the GI canceller 841b2 to convert a time domain signal to frequency domain signals.

The demapper 841b previously acquires information concerning mapping performed by the second communication device 400b, extracts the pilot symbol PS2 using the mapping information, and outputs the extracted pilot symbol PS2 to the channel state information calculator 842b.

The channel state information calculator 842b calculates channel state information of the channel from the second communication device 400b to the third communication device 700b by using the pilot symbol PS2 received from the radio signal restorer 841b.

(Factors for Errors being Included in Channel State Information CSI)

Hereinafter, factors for errors being included in channel state information CSI acquired by the first communication device 100b are explained.

In the first modification, a method of recognizing channel state information CSI is a method in which the first communication device 100b and the third communication device 700b calculate channel state information CSI, and the third communication device 700b transmits the channel state information CSI to the first communication device 100b through a wired line. Hereinafter, this method is referred to as a second method. The reason that an interference signal occurs is that a transmission signal of the third communication device 700b becomes the interference signal, similarly to the first embodiment.

Regarding the aforementioned first factor of the factors for errors being included in channel state information CSI, channel estimation errors occur when the first communication device 100b and the third communication device 700b perform channel estimation.

On the other hand, it is not necessary to consider the second factor if quantization errors when channel state information CSI is transmitted as a digital signal can be sufficiently reduced by the third communication device 700b transmitting the channel state information CSI to the first communication device 100b through a wired line.

Additionally, it is not necessary to consider the third factor if the granularity for transmitting channel state information CSI can be sufficiently increased by the third communication device 700b transmitting channel state information CSI to the first communication device 100b through a wired line.

Regarding the fourth factor, a channel varies when the second communication device 400b moves, thereby causing errors, similarly to the first embodiment.

Variances of these errors included in channel state information CSI can be acquired in a similar manner to the first embodiment.

Additionally, regarding the timing of transmitting the variance of errors in channel state information CSI, as for the first factor, the variance of errors is occasionally transmitted from the third communication device 700b to the first communication device 100b through a wired line since the first communication device 100b and the third communication device 700b perform channel estimation.

As for the fourth factor, the variance of errors is notified of when the variance calculator 532b of the second communication device 400b initiates communication using the present method, and when the moving speed or the Doppler frequency f_{d} of the second communication device 400b varies by a predetermined value or more. Instead of the second communication device performing notification again, the first communication device may calculate a variance of errors in channel state information CSI due to the second factor from the degree of a time variation of the channel state information CSI, after performing channel estimation multiple times.

A variance of errors in channel state information CSI in consideration of all the factors can be obtained by the variance acquirer calculating a sum of variances associated with the respective factors. Regarding the following processes, similar to the first embodiment, a variance of errors in channel state information is calculated using the variance of errors in channel state information CSI. Further, the variance of errors in channel state information is used to calculate the coefficient α, thereby enhancing the error rate characteristics of reception signals.

### (Second Modification)

Hereinafter, a second modification of the first embodiment is explained.

In the first embodiment, the case has been explained, in which the method of recognizing channel state information CSI is the method for the second communication device 400 to calculate the channel state information CSI, quantize the calculated channel state information CSI, and transmit the channel state information CSI as a digital signal, and the reason that an interference signal occurs is that a transmission signal from the third communication device 700 becomes the interference signal. On the other hand, in the second modification, a case is explained, in which a method of recognizing channel state information CSI is a method for a second communication device 400c to calculate channel state information CSI, quantize the calculated channel state information CSI, and transmit the channel state information CSI as a digital signal, and a reason that an interference signal occurs is that a delayed wave of a signal transmitted from the first communication device 100c becomes the interference signal. The delayed wave may be a signal transmitted from a transmission antenna of a relay station device connected to the first communication device c through a wired line.

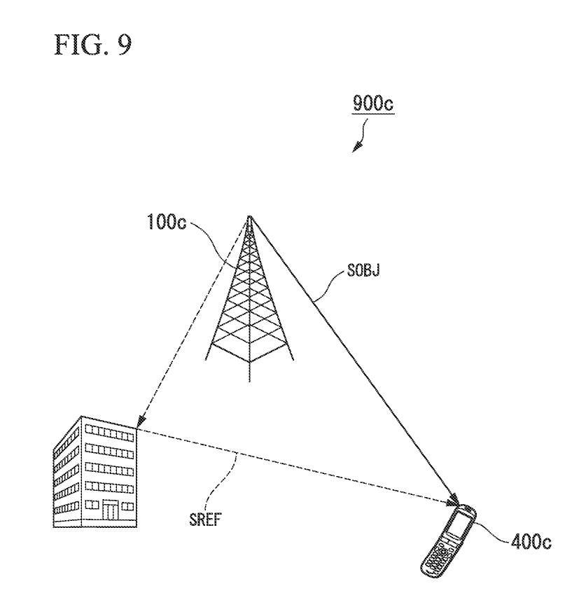

FIG. 9 is a diagram illustrating a configuration of the entire communication system.

In FIG. 9, a communication system 900c includes a first communication device 100c and a second communication device 400c.

The first communication device 100c transmits a radio signal SOBJ to the second communication device 400c through a channel with a channel state hₛ. The second communication device 400c receives the radio signal SOBJ. A delayed wave, which is the transmission signal of the first communication device 100c hitting against and reflected from a reflective object, thus passing through a channel (with a channel state h_{f}), becomes an interference signal SREF with respect to the second communication device 400c, and thus becomes an interference signal element included in the reception signal of the second communication device 400c.

In the present embodiment, when a transmission method used by the first communication device 100c is a communication method affected by ISI (Inter Symbol Interference), such as SC-FDM (Single Carrier-Frequency Division Multiplexing), inflated lattice precoding is used as a method of cancelling the ISI on a transmitting side.

In FIG. 9, a channel for a direct wave is denoted as hₛ, and a channel for a delayed wave is denoted as h_{f}.

### (Configuration of First Communication Device)

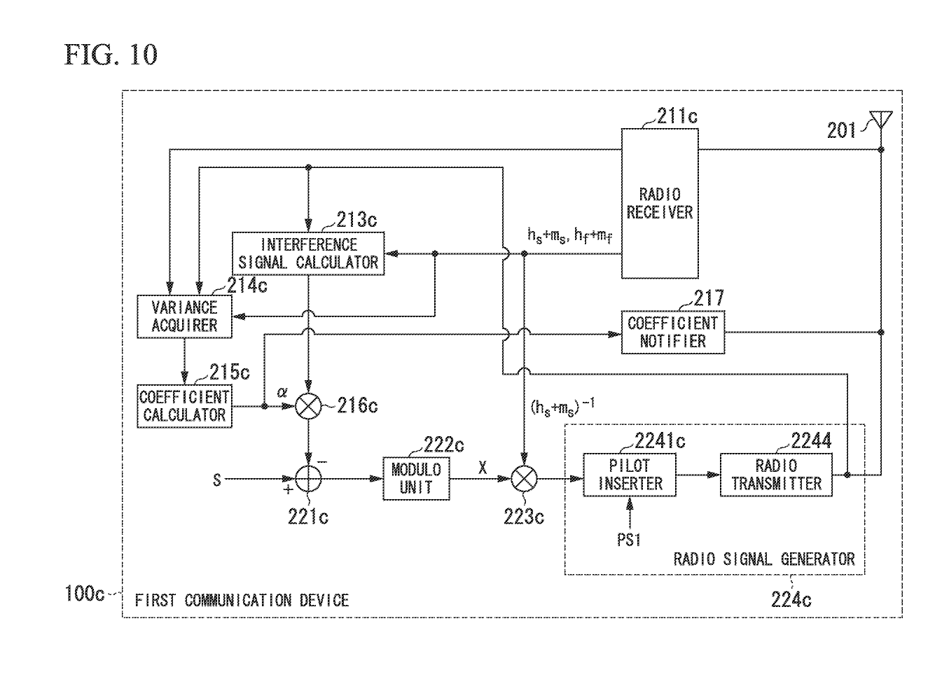

FIG. 10 is a schematic block diagram illustrating an example of a configuration of the first communication device 100c according to the second modification. The first communication device 100c differs from the first communication device 100 shown in FIG. 2 in that the first communication device 100c uses a time domain signal as a desired signal s.

In FIG. 10, the first communication device 100c includes: the antenna 201; a radio receiver 211c; an interference signal calculator 213c; a variance acquirer 214c; a coefficient calculator 215c; a coefficient multiplier 216c; a coefficient notifier 217; an interference signal subtractor 221c; a modulo unit 222c; a channel divider 223c; and a radio signal generator 224c.

The radio signal generator 224c includes a pilot inserter 2241c and a radio transmitter 2244.

The radio receiver 211c receives channel state information of a direct wave, channel state information of a delayed wave, and variances that will be explained later, from the second communication device 400c through the antenna 201. As the channel state information, a channel impulse response estimation value is received.

The interference signal calculator 213c calculates an estimation value of an interference signal included in a reception signal of the second communication device 400c, based on a transmission signal of the first communication device 100c which is received from the radio transmitter 2244, and the channel state information of the channel for the interference signal which is received from the radio receiver 211c.

The variance acquirer 214c receives from the radio receiver 211c, a variance that will be explained later.

The coefficient calculator 215c calculates, based on the variance received from the variance acquirer 214c, the coefficient α by which the interference signal estimation value is multiplied.

The coefficient multiplier 216c multiplies the interference signal estimation value received from the interference signal calculator 213c by the coefficient α received from the coefficient calculator 215c.

The coefficient notifier 217 transmits the coefficient α received from the coefficient calculator 215c to the second communication device 400c through the antenna 201. For example, the coefficient α is included in a control channel of a general SC-FDM transmission signal for which a modulo arithmetic or the like is not performed, thereby enabling the transmission of the coefficient α to be performed even before communication using the method of the present invention becomes available.

The interference signal subtractor 221c subtracts from the signal s of which the first communication device 100c notifies the second communication device 400c, the interference signal estimation value multiplied by the coefficient α, which is received from the coefficient multiplier.

The modulo unit 222c performs modulo arithmetic on the signal that has been subjected to the subtraction and received from the interference signal subtractor 221c.

The channel divider 223c divides the signal that has been subjected to the modulo arithmetic and received from the modulo unit 222c, by the channel state information of the channel from the first communication device 100c to the second communication device 400c, which is received from the radio receiver 211c.

The pilot inserter 2241c of the radio signal generator 224c inserts the pilot symbol PS1 into the signal that has been subjected to the division and received from the channel divider 223c.

The radio transmitter 2244 performs digital-to-analog conversion, frequency conversion, and the like, on the signal with the pilot symbol PS1 inserted, which is received from the pilot inserter 2241c. Then, the radio transmitter 2244 transmits the converted signal through the antenna 201.

### (Configuration of Second Communication Device)

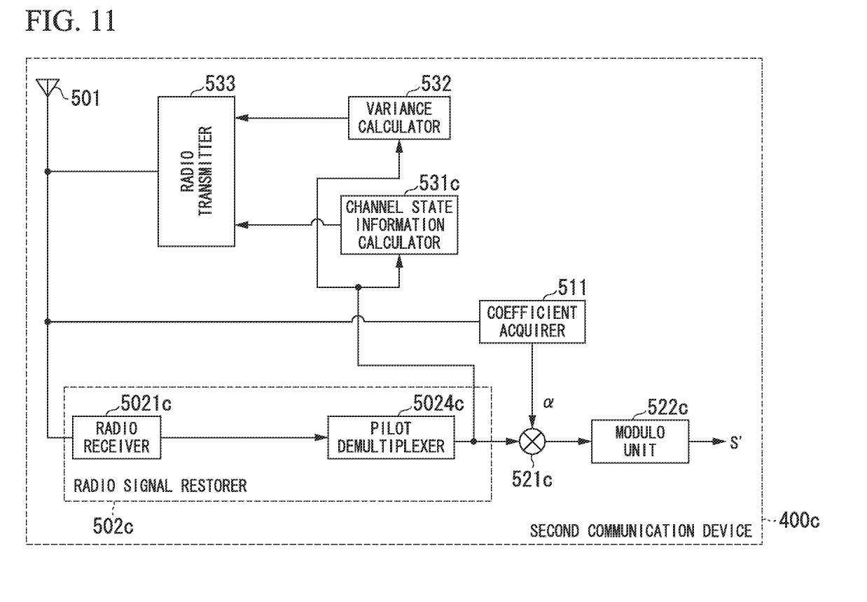

FIG. 11 is a schematic block diagram illustrating a configuration of the second communication device 400c according to the second modification.

In FIG. 11, the second communication device 400c includes: the antenna 501; a radio signal restorer 502c; the coefficient acquirer 511; a coefficient multiplier 521c; a modulo unit 522c; a channel state information calculator 531c; a variance calculator 532; and a radio transmitter 533.

The radio signal restorer 502c includes a radio receiver 5021c, and a pilot demultiplexer 5024c.

The radio receiver 5021c performs frequency conversion, analog-to-digital conversion, and the like, on a radio signal that is transmitted from the first communication device 100c and received through the antenna 501.

The pilot demultiplexer 5024c previously acquires information concerning insertion of the pilot symbol performed by the first communication device 100c. The pilot demultiplexer 5024c extracts the pilot symbol PS1 from a reception signal received from the radio receiver 5021c by using the information, and outputs the extracted pilot symbol PS1 to the channel state information calculator 521c.

The coefficient calculator 511 receives the coefficient α from the first communication device 100c through the antenna 501.

The coefficient multiplier 521c multiplies the signal received from the radio signal restorer 502c by the coefficient α received from the coefficient acquirer 511.

The modulo unit 522c performs, on the signal that has been subjected to the multiplication and received from the coefficient multiplier 521c, the same modulo arithmetic as performed by the modulo unit 222c of the first communication device 100c (shown in FIG. 10).

Using the pilot symbol PS1 received from the radio signal restorer 502c, the channel state information calculator 531c calculates channel state information of a direct wave and channel state information of an interference wave, the direct wave and the interference wave being of the channel from the first communication device 100c to the second communication device 400c. Here, a channel impulse response is calculated as the channel state information. The direct wave and the interference wave are demultiplexed using the impulse response.

The variance calculator 532 calculates, based on the input from the pilot demultiplexer 5024c, a variance that will be explained later.

The radio transmitter 533 transmits, to the first communication device 100c through the antenna 501, the channel state information of the direct wave and the channel state information of the interference wave which are received from the channel state information calculator 531c, and the variances received from the variance calculator 532.

(Reason for Errors being Included in Channel State Information Csi)

Hereinafter, a factor for errors being included in the channel state information CSI acquired by the first communication device 100c is explained.

In the second modification, a method of recognizing channel state information CSI is a method in which the second communication device 400c calculates channel state information CSI, quantizes the calculated channel state information CSI, and transmits the quantized channel state information CSI as a digital signal. The reason that an interference signal occurs is that a delayed signal of a transmission signal of the first communication device 100c becomes the interference signal.

Regarding the first factor of the factors for errors being included in channel state information CSI, channel estimation errors occur when the second communication device 400c performs channel estimation.

Regarding the second factor, quantization errors occur when the second communication device 400c quantizes channel state information and transmits the quantized channel state information as a digital signal to the first communication device 100c.

The third factor is not considered since single-carrier communication is performed.

Regarding the fourth factor, a channel varies when the second communication device 400c moves, thereby causing errors, similarly to the first embodiment.

Variances of these errors included in the channel state information CSI can be acquired in a similar manner to the first embodiment.

Regarding the timing of transmitting the variances of errors included in the channel state information CSI, as for the first factor, the variance calculator 532 of the second communication device 400c notifies the first communication device 100c of the variance when communication by the present method is initiated and when the average reception power varies by a predetermined value or more.

As for the second factor, the first communication device can acquire the variance by itself, and therefore does not need to transmit the variance to the second communication device.

As for the fourth factor, the variance calculator 532 of the second communication device 400c notifies of the variance when communication by the present method is initiated and when the moving speed of the second communication device varies by a predetermine value or more.

A variance of errors in the channel state information CSI in consideration of all the factors can be obtained by the variance acquirer calculating a sum of the variances due to the respective factors. In the following processes, similarly to the first embodiment, a variance of errors in channel state information is calculated using the variance of the errors in the channel state information CSI. Then, the variance of errors in channel state information is used to calculate the coefficient α, thereby enhancing the error rate characteristics of the reception signal.

### (Third Modification)

Hereinafter, a third modification of the first embodiment is explained.

In the third modification, a case is explained, in which a method of recognizing channel state information CSI is a method for a first communication device 400c to calculate channel state information CSI using the reversibility of a channel, and the reason that an interference signal occurs is that a delayed wave of a signal transmitted from the first communication device 100c becomes the interference signal.

### (Configuration of First Communication Device)

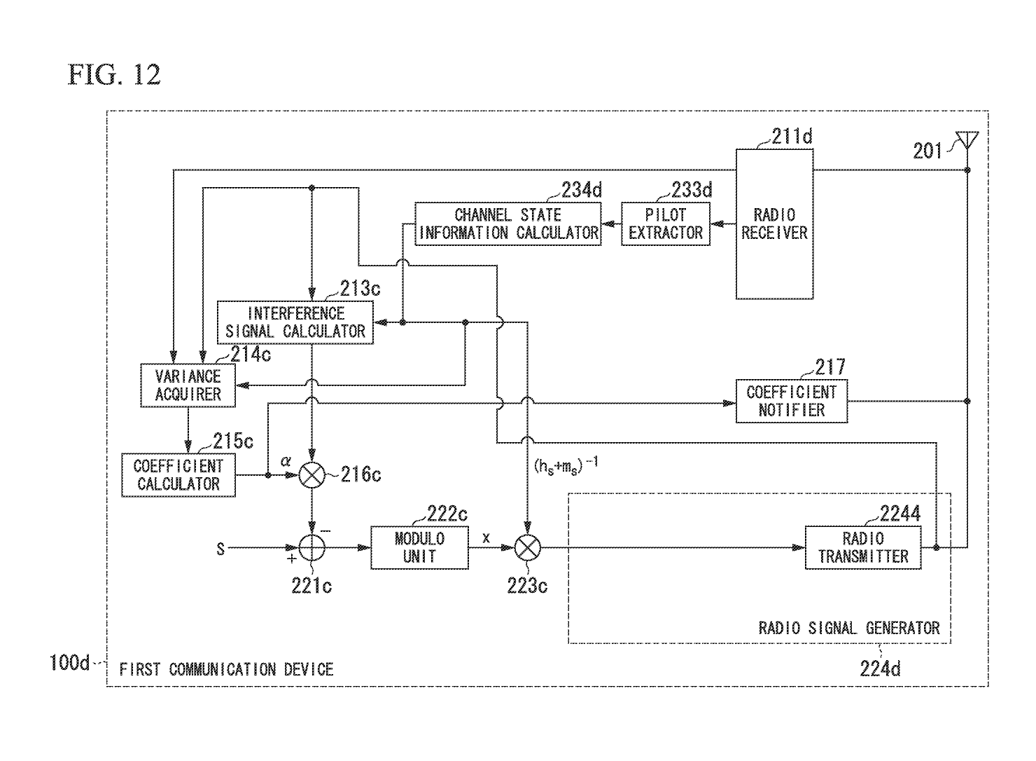

FIG. 12 is a schematic block diagram illustrating an example of a configuration of the first communication device 100d according to the third modification.

In FIG. 12, the same reference numerals (201, 213c, 214c, 215c, 216c, 217, 221c, 222c, 223c, and 2244) are appended to units corresponding to those shown in FIG. 10, and explanations thereof are omitted here.

The first communication device 100d shown in FIG. 12 differs from the first communication device 100c shown in FIG. 10 in that the first communication device 100d is configured to include a pilot extractor 233d and a channel state information calculator 234d, and that the first communication device 100d does not include the pilot inserter 2241c.

The radio receiver 211d receives from a second communication device 400d through the antenna 201, a pilot signal and variances that will be explained later.

The pilot extractor 233d previously acquires information concerning insertion of a pilot signal, which is performed by the second communication device 400d. The pilot extractor 233d extracts a pilot symbol PS2 from the reception signal received from the radio receiver 211d, and outputs the extracted pilot symbol PS2 to the channel state information calculator 234d.

The channel state information calculator 234d calculates channel state information using the pilot symbol PS2 received from the pilot extractor 233d. As the channel state information, a channel impulse response is calculated.

### (Configuration of Second Communication Device)

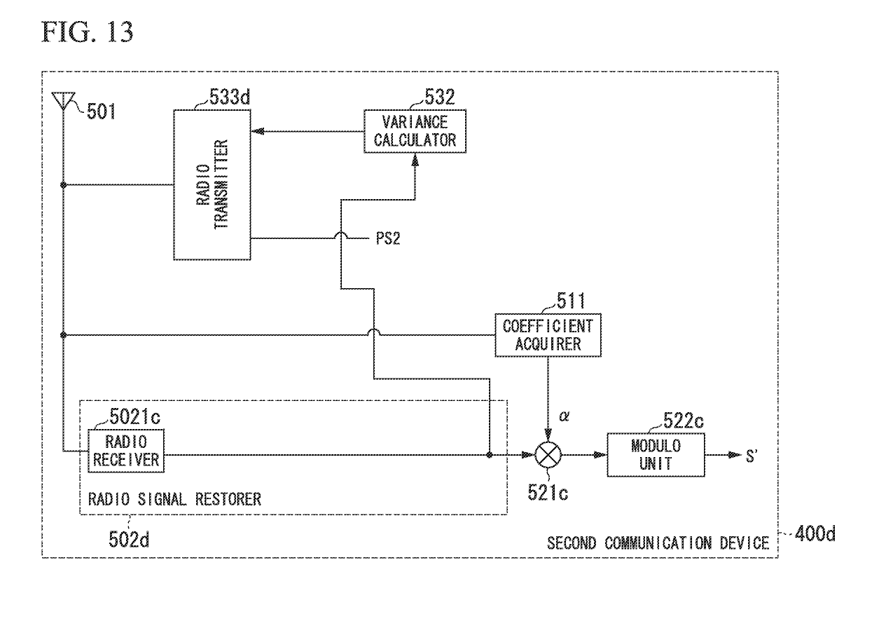

FIG. 13 is a schematic block diagram illustrating an example of a configuration of the second communication device 400d according to the third modification. In FIG. 13, the same reference numerals (501, 521c, 511, 521c, 522c, and 532) are appended to units corresponding to those shown in FIG. 11, and explanations thereof are omitted here.

The second communication device 400d shown in FIG. 13 differs from the second communication device 400c shown in FIG. 11 in that a radio transmitter 533d receives the pilot symbol PS2, and that the second communication device 400d does not include the pilot extractor 5024c.

The radio transmitter 533d inserts the pilot symbol PS2 into the information concerning the variance received from the variance calculator 532, performs digital-to-analog conversion, frequency conversion, and the like, on the information with the pilot symbol PS2 inserted, transmits the resultant signal through the antenna 501.

### (Reason for Errors Being Included in Channel State Information CSI)

Hereinafter, factors for errors being included in the channel state information CSI acquired by the first communication device 100d are explained.

In the third modification, a method of recognizing channel state information CSI is a method for the first communication device 100d to calculate the channel state information CSI. The reason that an interference signal occurs is that a delayed signal of a transmission signal of the first communication device 100d becomes the interference signal.

Regarding the first factor of the factors for errors being included in the channel state information, channel estimation errors occur when the first communication device 100d performs channel estimation.

Regarding the second factor, it is not necessary for the second communication device 400d to transmit channel state information CSI since the first communication device 100d performs channel estimation. Accordingly, quantization errors do not occur.

The third factor is not considered since single-carrier communication is performed.

Regarding the fourth factor, a channel varies when the second communication device 400 moves, thereby causing errors, similarly to the first embodiment.

Variance of these errors included in the channel state information CSI can be acquired in a similar manner to the first embodiment.

Regarding the timing of transmitting the variances of the errors included in the channel state information CSI, as for the first factor, the variance acquirer 214c of the first communication device 100d can occasionally calculate the variance of the errors due to the first factor since the first communication device 100d performs channel estimation.

As for the fourth factor, the variance acquirer 532 of the second communication device 400d notifies of the variance due to the fourth factor when communication by the present method is initiated and when the moving speed of the second communication device or the maximum Doppler frequency f_{d} varies by a predetermined value or more.

A variance of errors in the channel state information in consideration of all the factors can be obtained by the variance acquirer calculating a sum of variances associated with the respective factors. In the following processes, similar to the first embodiment, a variance of errors in channel state information is calculated using the variance of the errors in the channel state information CSI, the variance of the errors in the channel state information is used to calculate the coefficient α, thereby enhancing the error rate characteristics.

### Second Embodiment

In a second embodiment, an embodiment in which the present invention is performed by a first communication device that applies THP to inter-stream interferences in a case of MU-MIMO (Multi User-Multi Input Multi Output) is explained.

MU-MIMO is a communication method in which a transmission device has multiple antennas, and multiple data streams with respect to multiple reception devices are simultaneously communicated using the same frequency band. In the case of MU-MIMO, the data streams interfere with one another. One of methods of a transmission device previously cancelling the inter-stream interferences before performing transmission is called MU-MIMO THP.

In a case of MU-MIMO THP, it is desirable for a transmission side to precisely recognize channel state information pieces CSI of channels from all the transmission antennas to reception antennas. However, it is impossible to precisely recognize the channel state information pieces CSI without errors. In other words, as a result, errors are included in the channel state information CSI, similarly to the first embodiment. For this reason, errors are included in an interference signal element (inter-stream interference in the case of the second embodiment) to be recognized by the transmission signal, similarly to the first embodiment.

In the second embodiment, a variance σₘ² of errors in inter-stream interferences is calculated from a variance of errors included in channel state information CSI. Thus, the coefficient α is calculated using the variance σₘ², a variance σₓ² of a transmission signal, and a variance σₙ² of noise, similarly to the first embodiment. The inflated lattice precoding using the coefficient α is performed in the case of MU-MIMO, thereby enhancing the error rate characteristics of a reception signal.

A first communication device 101 of the second embodiment includes N pieces of antennas, and communicates with N pieces of second communication devices. Each of the second communication devices is configured to include one antenna. The second communication device performs channel estimation using pilot symbols transmitted independently from the respective N antennas of the first communication device, and transmits channel state information CSI to the first communication device 101.

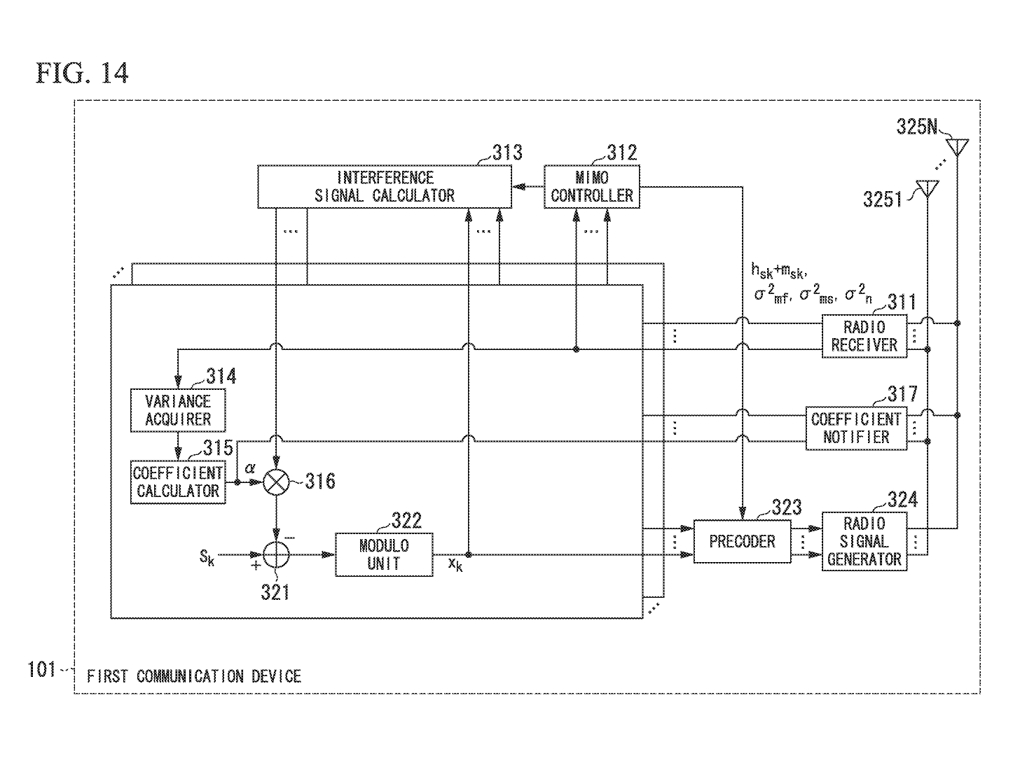

FIG. 14 is a schematic block diagram illustrating a configuration of the first communication device 101 according to the second embodiment of the present invention.

In FIG. 14, the first communication device 101 includes: N pieces of antennas 3011 to 301N; a radio receiver 311; an MIMO controller 312; an interference signal calculator 313; N pieces of variance acquirers 314; N pieces of coefficient calculators 315; N pieces of coefficient multiplier 316; N pieces of interference signal subtractors 321; N pieces of modulo units 322; a precoder 323; and a radio signal generator 324.

The radio receiver 311 receives channel state information pieces CSI and variances from the second communication device through the antennas 3011 to 301N.

Here, characteristics of a channel from the s-th antenna 301s of the first communication device 101 to the k-th second communication device is denoted as hₛₖ. The hₛₖ is characteristic of a channel including no error at the time the first communication 101 transmits a signal. Since the first communication device 101 includes the N pieces of antennas, the characteristics of the channels to the k-th second communication can be expressed by an N-dimensional complex vector.

Similar to the first embodiment, errors are included in channel state information CSI acquired by the first communication device 101. When an error in the channel state information CSI of a channel from the s-th antenna 301s to the k-th second communication device is denoted as mₛₖ, the first communication device 101 acquires hₛₖ+mₛₖ as the channel state information CSI.

The MIMO controller 312 receives the channel state information CSI from the radio receiver 311, and calculates a precoding matrix P and an interference coefficient matrix F for MU-MIMO. The MIMO controller 312 inputs the calculated precoding matrix P to the precoder 323, and inputs the interference coefficient matrix F to the interference signal calculator 313. The MIMO controller 312 calculates P and F from hₛₖ+mₛₖ as follows. Here, F is a lower triangular matrix, the diagonal elements of which are 0.

A channel matrix H′ acquired by the first communication device 101 is denoted as the expression (11).

[Expression 11]

H′=[hₛ₁+mₛ₁ . . . h_{sN}+m_{sN}]^{T} Expression (11)

Here, T denotes transposition. In other words, H′ is a matrix such that an element of the k-th row and the m-th column is a channel associated with the m-th transmission antenna, which is received by the k-th second communication device. The MIMO controller 312 performs QR decomposition on H′ and H. Here, H denotes Hermitian conjugate. Based on these, the MIMO controller 312 generates an upper triangular matrix R and a unitary matrix Q so as to satisfy the expression (12).

[Expression 12]

H′^{H}=QR Expression (12)

Where an element of the k-row and 1-column of each matrix is defined as follows:

H′={h′ₖₗ}

Q={qₖₗ}

R={rₖₗ}

P={pₖₗ}

F={fₖₗ}

$${h}_{lk}^{′ *} = {\sum }_{l = 1}^{K} {q}_{kl} {r}_{lm}$$

The MIMO controller 312 performs an operation to take Hermitian conjugate for both sides, and obtains an expression (13).

$$\begin{matrix}[ Expression 13 ] & \\ {H}^{′} = {R}^{H} {Q}^{H} \\ {h}_{kl}^{′} = {\sum }_{l = 1}^{K} {r}_{lm}^{*} {q}_{kl}^{*} \\ {a}_{kl} = \{ \begin{matrix}1 / {r}_{kl} & ( k = l ) \\ 0 & ( k \neq l )\end{matrix} \\ \begin{matrix}{p}_{km} = {\sum }_{l = 1}^{K} {q}_{kl} {a}_{lm} \\ = {q}_{km} / {r}_{mm}\end{matrix} \\ \begin{matrix}{f}_{km} = {e}_{km} - {\sum }_{n = 1}^{K} {\sum }_{l = 1}^{K} {h}_{kn} {q}_{nl} {a}_{lm} \\ = {e}_{km} - {\sum }_{l = 1}^{K} {h}_{kl} {p}_{lm}\end{matrix} & Expression ( 13 )\end{matrix}$$

Here, R^{H} denotes a lower triangular matrix. The MIMO controller 312 generates a diagonal matrix A where an inverse of an element of the k-th row and k-th column of R is substituted in an element of the k-th row and k-th column of A.

Additionally, the MIMO controller 312 calculates the precoding matrix P=QA, and outputs the precoding matrix to the precoder 323. Further, the MIMO controller 312 calculates the interference coefficient matrix F=I−HQA, and inputs the interference coefficient matrix to the interference signal calculator 313.

Although it has been explained in the second embodiment that the interference signal calculator 313 generates the precoding matrix P and the interference coefficient matrix F using the QR decomposition, the configuration is not limited thereto. A method of changing the order of transmission signals to be transmitted to the second communication devices based on the characteristics of channels for the respective second communication devices, with use of a sorted QR decomposition, may be used.

Hereinafter, operations of the interference signal calculator 313 are explained. The interference coefficient matrix F input by the MIMO controller is a matrix indicating correlation of inter-stream interferences (also referred to as multi-user interferences in the case of MU-MIMO) between data streams to be transmitted to the second communication devices. An element of the k-th row and m-th column of the matrix F corresponds to an interference of a transmission signal to be transmitted to the m-th second communication device with the k-th second communication device. In other words, an interference of the transmission signal to be transmitted to the m-th second communication device with the k-th second communication device can be expressed as the expression (14).

[Expression 14]

fₖₘxₘ Expression (14)

Here, xₘ is a transmission signal to be transmitted to the m-th second communication device.

The interference signal calculator 313 generates, by calculating an expression (15), an element of interference with the k-th second communication device, which is caused by signals to be transmitted to other second communication devices.

$$\begin{matrix}[ Expression 15 ] & \\ {\sum }_{m = 1}^{k - 1} {f}_{km} {x}_{m} & Expression ( 15 )\end{matrix}$$

Here, as explained above, F is a lower triangular matrix, the diagonal elements of which are 0. The 1st second communication device is not subjected to any interference caused by transmission signals to be transmitted to other second communication devices. The k-th second communication device is subjected to interferences caused by only signals to be transmitted to the 1st to (k−1)-th second communication devices.

Accordingly, the interference signal calculator 313 calculates transmission signals sequentially from a transmission signal of the 1st second communication device, and thereby can calculate transmission signals up to a transmission signal of the N-th second communication device.

The variance acquirer 314 calculates a variance of errors in an interference signal element due to errors in channel state information CSI. Similar to the first embodiment, also in the second embodiment, errors occur due to the first to fourth factors. Accordingly, variances due to errors included in channel state information CSI can be calculated.

Additionally, the variance acquirer 314 calculates a variance σₓ² of a transmission signal xₘ and a variance σₙ² of noise, similarly to the first embodiment.

Regarding a method of calculating a variance of errors in an interference element, for example, the number of transmission and reception antennas and the like are previously set according to environments simulated with use of, for example, Monte Carlo simulation, and thereby the variance may be previously calculated. Alternatively, a method of calculating a variance of errors in other inter-stream interferences may be used. Thus, a variance of errors in an interference element is expressed as a function of a variance of errors included in channel state information CSI, thereby enabling calculation of a variance of errors in an interference element. The calculated variance is denoted as σₘ². The variances σₓ², σₙ², and σₘ², which are calculated in the above manner, are input to the coefficient calculator 315.

The coefficient calculator 315 calculates α using an expression (16) similarly to the previous embodiment. In other words, the coefficient calculator 315 calculates the coefficient α based on a variance of channel estimation errors associated with a channel for a desired signal, and a variance of noise.

$$\begin{matrix}[ Expression 16 ] & \\ α = \frac{{σ}_{x}^{2}}{{σ}_{n}^{2} + {σ}_{m}^{2} + {σ}_{x}^{2}} & Expression ( 16 )\end{matrix}$$

The coefficient calculator 315 inputs α to the coefficient calculator 316.

The coefficient calculator 316 multiplies the interference element received from the interference signal calculator 313 by α, thus generates the expression (17), and inputs the expression (17) to the interference signal subtractor 321.

$$\begin{matrix}[ Expression 17 ] & \\ α {\sum }_{m = 1}^{N} {f}_{km} {x}_{m} & Expression ( 17 )\end{matrix}$$

The interference signal subtractor 321 subtracts an interference signal element multiplied by the coefficient α from a modulation symbol sₖ to be transmitted to the k-th second communication device, and inputs the resultant signal to the modulo unit 322.

The modulo unit 322 performs a modulo arithmetic similar to the expression (4) of the first embodiment. The signal resulting from the modulo arithmetic becomes a transmission signal xₖ to be transmitted to the k-th second communication device. The modulo unit 322 inputs the transmission signal xₖ to the precoder 323 and the interference signal calculator 313.

The interference signal calculator 313 uses the transmission signal xₖ to calculate interference signal elements with respect to the (k+1)-th second communication device and the following second communication devices.

The above operations are repeated from k=1 to k=N, the repeated number of times of which corresponds to the number of second communication devices. In the case of the 1st second communication device, there is no interference caused by a transmission signal to be transmitted to other second communication devices, and therefore the subtractor subtracts nothing.

The precoder 323 multiplies, by the matrix P received from the MIMO controller, the vector shown in the expression (18) which can be obtained by gathering transmission signals xₖ to be transmitted to each second communication device, thereby generating z=Px.

[Expression 18]

x=[x₁, . . . , x_{N}]^{T} Expression (18)

Each element of z denotes a signal to be transmitted from associate one of the transmission antennas. The precoder 323 inputs z to the radio signal generator 324.

The radio signal generator 324 generates, for each antenna, OFDM signals with respect to the elements of z, similarly to the radio signal generator shown in FIG. 2. Then, the radio signal generator 324 transmits the generated OFDM symbols. The radio signal generator 324 simultaneously transmits multiple desired signals using the same frequency.

The mapper 3241 maps the signals received from the precoder 323 and a pilot symbol PS to resource elements for OFDM symbols.

The IFFT unit 3242 performs an IFFT process on the signals that has been mapped and received from the mapper 3241, to convert frequency domain signals to a time domain signal.

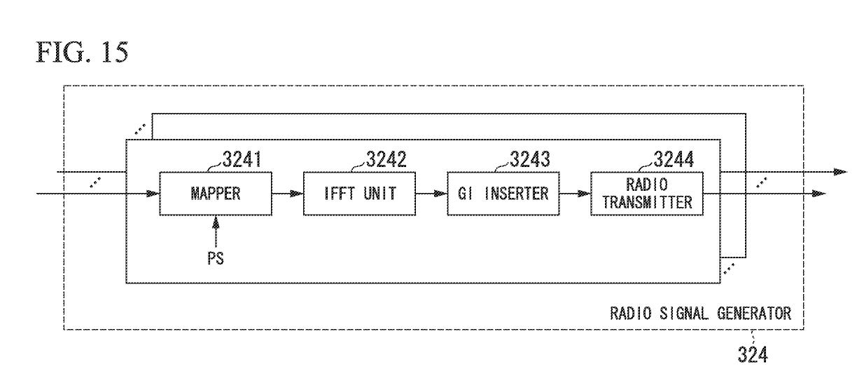

FIG. 15 is a schematic block diagram illustrating a configuration of the radio signal generator 324 according to the second embodiment.

In FIG. 15, a GI inserter 3243 adds a guard interval to the time domain signal received from the IFFT unit 3242.

The radio transmitter 3244 performs digital-to-analog conversion, frequency conversion, or the like, on the time domain signal with the guard interval added, which is received from the GI inserter 3243. Then, the radio transmitter 3244 transmits the converted signal through the antennas 3251 to 325N.

The coefficient notifier 317 transmits the coefficient α received from the coefficient calculator to the respective second communication device 400 using the antennas 3251 to 325N.

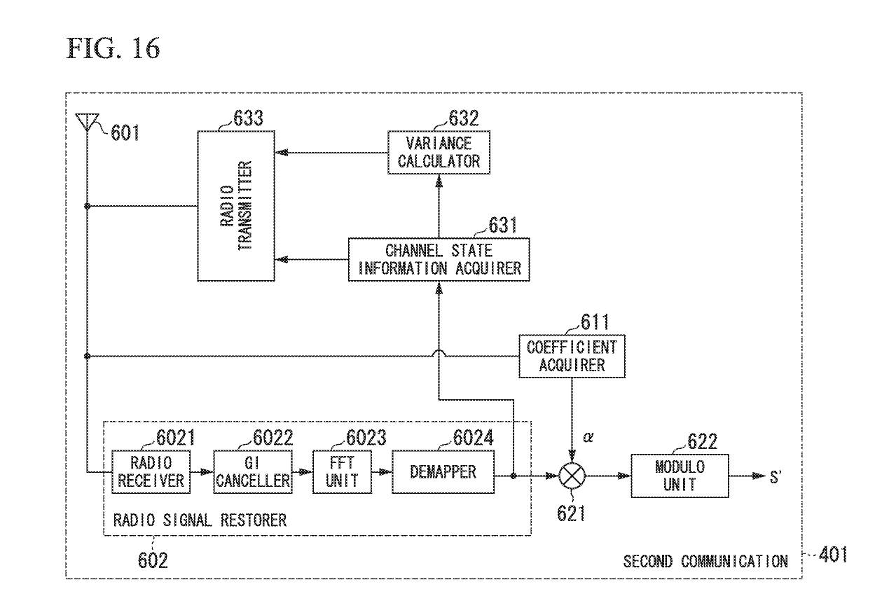

FIG. 16 is a schematic block diagram illustrating a configuration of a second communication device 401 according to the second embodiment. In FIG. 16, the second communication device 401 includes: an antenna 601; a radio signal restorer 602; a coefficient acquirer 611; a coefficient multiplier 621; a modulo unit 622; a channel state information calculator 631; a variance calculator 632; and a radio transmitter 633.

The radio signal restorer 602 includes: a GI canceller 6022; an FFT unit 6023; a GI canceller 6022; an FFT unit 6023; and a demapper 6024.

The antenna 601, the radio receiver 6021, the FFT unit 5023, the coefficient acquirer 611, the coefficient multiplier 621, and the modulo unit 622, which are shown in FIG. 16, correspond to the antenna 501, the GI canceller 5022, the coefficient acquirer 511, the coefficient multiplier 521, and the modulo unit 522, which are shown in FIG. 3, respectively.

The radio receiver 6021 performs frequency conversion, analog-to-digital conversion, and the like, on a radio signal received from the first communication device 101 through the antenna 601.

The demapper 6024 previously acquires information concerning the mapping performed by the first communication device 101. Using the mapping information, the demapper 6024 arranges the data symbols received from the FFT unit 6023 in the same order as of the original data symbols (at the time of transmission). Additionally, the demapper 6024 extracts the pilot symbol PS using the mapping information, and outputs the extracted pilot symbol PS to the channel state information calculator 631.

The channel state information calculator 631 calculates, using the pilot symbol PS received from the radio signal restorer 602, channel state information of a channel from each antenna of the first communication device 101 to the second communication device 401. Additionally, the channel state information calculator 631 calculates an S/N ratio of a reception signal and a delay spread of the reception signal, and outputs the calculated S/N ratio and the delay spread to the variance calculator 632.

The variance calculator 632 calculates information concerning a variance of channel estimation errors, information concerning a variance of errors according to CSI transmission granularity, and information concerning a variance of errors due to a channel variation, by using the S/N ratio of the reception signal and the delay spread of the reception signal, which are received from the channel state information calculator 631.

The radio transmitter 633 transmits, to the first communication device 101 through the antenna 601, the channel state information of the channel from each antenna of the first communication device 101 to the second communication device 401, which is received from the channel state information calculator 631, and the variance received from the variance calculator 632.

As explained above, according to the second embodiment, similar to the first embodiment, the coefficient α for the inflated lattice precoding is calculated using a variance of a transmission signal, a variance of noise, and a variance of errors in an interference signal. Accordingly, a receiving side can make an average of the total power of remaining interferences and noise (a variance of the difference between a desired signal sₖ to be transmitted and an estimation value of sₖ) smaller than when THP is simply used, or smaller than a value of σₓ²σₙ²/(σₙ²+σₓ²) when α=σₓ²/(σₙ²+σₓ²) in the case of the inflated lattice precoding.

The first communication device 101 may perform communication using SU-MIMO (Single User-Multi Input Multi Output). SU-MIMO is a communication method in which each of a transmission device and a reception device has multiple antennas, and multiple data streams are simultaneously communicated using the same frequency band. Even in the case of SU-MIMO, multiple data streams interfere with one another. For this reason, similar to the case of MU-MIMO, a variance of a transmission signal, a variance of noise, and a variance of errors in an interference signal are used to calculate the coefficient α for the inflated lattice precoding, thereby enhancing the error rate characteristics.

A computer readable recording medium may record a program for implementing: the entire or part of the first communication device 100 shown in FIG. 2; the entire or part of the second communication device 400 shown in FIG. 3; the entire or part of the third communication device 700 shown in FIG. 4; the entire or part of the first communication device 100b shown in FIG. 6; the entire or part of the third communication device 700b shown in FIG. 8; the entire or part of the first communication device 100c shown in FIG. 10; the entire or part of the second communication device 400c shown in FIG. 11; the entire or part of the first communication device 100d shown in FIG. 12; the entire or part of the second communication device 400d shown in FIG. 13; and the entire or part of the first communication device 101 shown in FIG. 14, which are explained above. Then, processes for the respective units may be performed by a computer system reading and executing the program recorded in the recording medium. The “computer system” includes OS and hardware, such as a peripheral device.

Additionally, the “computer system” includes a home page providing environments (or displaying environments) if using a WWW system.

Further, the “computer readable recording medium” includes a portable medium such as a flexible disc, a magneto-optical disc, a ROM, and a CD-ROM, and a storage device such as a hard disk built in the computer system. The “computer readable recording medium” may include a medium that dynamically stores a program for a short period of time, such as a communication line used when a program is transmitted via a network such as the Internet or a communication line such as a telephone line. Additionally, the “computer readable recording medium” may include a medium that stores a program for a predetermined period of time, such as a volatile memory built in a computer system serving as a server or client when the program is transmitted via a network such as the Internet or a communication line such as a telephone line. Additionally, the program may be a program for implementing part of the aforementioned functions. Further, the program may be a program that can implement the aforementioned functions in combination with a program already recorded on the computer system.

Although embodiments of the present invention have been explained in detail with reference to the drawings, the specific configuration is not limited to those embodiments, and various design modifications and the like may be made without departing from the scope of the present invention.

### INDUSTRIAL APPLICABILITY

The present invention is suitable to be used by a mobile communication system, and is also applicable to a fixed communication system.

### DESCRIPTION OF REFERENCE NUMERALS

100, 100b, 100c, 100d, and 101: first communication device
211, 211c, and 311: radio receiver
212: interference source transmission signal acquirer
213, 213c, and 313: interference signal calculator
214, 214c, and 314: variance acquirer
215, 215c, and 315: coefficient calculator
216, 216c, 316, 521, and 521c: coefficient multiplier
217 and 317: coefficient notifier
221, 221c, and 321: interference signal subtractor
222, 222c, 322, 522, and 522c: modulo unit
223 and 223c: channel divider
224, 224c, and 324: radio signal generator
231b: GI canceller
232b: FFT unit
233b: demapper
233d; pilot extractor
234b, 234d, 531, and 531c: channel state information calculator
312: MIMO controller
323: precoder
400, 400b, 400c, and 400d: second communication device
502 and 502c: radio signal restorer
511: coefficient acquirer
532: variance calculator
533 and 533b: radio transmitter
700 and 700b: third communication device
824: radio signal generator
831: interference source transmission signal notifier
841b: radio signal restorer
900 and 900c: communication system

1. An interference suppression wireless communication device to be used in an interference suppression wireless communication system, comprising:
a variance acquirer configured to acquire at least one of a variance of channel estimation errors associated with a channel for a transmission signal of the interference suppression wireless communication device and a variance of channel estimation errors associated with a channel for an interference signal, and acquire a variance of noise included in the transmission signal when the transmission signal is received; and
a coefficient calculator configured to calculate, based on the variances acquired by the variance acquirer, a coefficient by which the interference signal to be subtracted from the transmission signal is multiplied.

2. The interference suppression wireless communication device according to claim 1, wherein
the variance acquirer is configured to generate a variance of the transmission signal, and
the coefficient calculator is configured to calculate the coefficient using also the variance of the transmission signal.

3. The interference suppression wireless communication device according to claim 2, wherein
the variance acquirer is configured to calculate, using the variance of the channel estimation errors associated with the channel for the transmission signal, a variance of errors in channel state information associated with the channel for the transmission signal,
the variance acquirer is configured to calculate, using the variance of the channel estimation errors associated with the channel for the interference signal, a variance of errors in channel state information associated with the channel for the interference signal, and
the variance acquirer is configured to acquire a variance of an interference signal calculated from the interference signal for an interference source, in order to calculate a variance of errors in the interference element.

4. The interference suppression wireless communication device according to claim 3, wherein
the variance acquirer is configured to acquire the variance of the channel estimation errors associated with the channel for the interference signal,
the variance acquirer is configured to acquire, in addition to the variance of the channel estimation errors associated with the channel for the interference signal, at least one of a variance of errors according to granularity for transmitting the channel state information, a variance of errors due to channel variation associated with the channel for the interference signal, and a variance of quantization errors in the channel state information associated with the channel for the interference signal,
the variance acquirer is configured to calculate a variance of errors in the channel state information associated with the channel for the interference signal by calculating a sum of the at least one of the variances acquired,
the variance acquirer is configured to acquire the variance of the channel estimation errors associated with the channel for the transmission signal,
the variance acquirer is configured to acquire, in addition to the variance of the channel estimation errors associated with the channel for the transmission signal, at least one of a variance of errors according to granularity for transmitting the channel state information, a variance of errors due to channel variation associated with the channel for the transmission signal, and a variance of quantization errors in channel state information associated with the channel for the transmission signal, and
the variance acquirer is configured to calculate a variance of errors in the channel state information associated with the channel for the interference signal by calculating a sum of the at least one of the variances acquired.

5. The interference suppression wireless communication device according to claim 3, wherein
the variance acquirer is configured to generate, based on a method of transmitting the channel state information associated with the channel for the interference signal, the variance of the quantization errors in the channel state information associated with the channel for the interference signal, and
the variance acquirer is configured to generate, based on a method of transmitting the channel state information associated with the channel for the transmission signal, the variance of the quantization errors in the channel state information associated with the channel for the transmission signal.

6. An interference suppression wireless communication device, comprising:
a channel state information acquirer configured to calculate channel state information associated with a channel for an interference signal, and channel state information associated with a channel for a transmission signal;
a radio receiver configured to calculate an average reception power of a reception signal;
a variance calculator configured to calculate, when communication is initiated and during the communication, a variance of channel estimation errors associated with the channel for the interference signal which are generated when the channel state information associated with the channel for the interference signal is calculated, and a variance of channel estimation errors associated with the channel for the transmission signal which are generated when the channel state information associated with the channel for the transmission signal is calculated; and
a radio transmitter configured to transmit the channel state information associated with the channel for the interference signal, the channel state information associated with the channel for the transmission signal, the variance of the channel estimation errors associated with the channel for the interference signal, and the variance of the channel estimation errors associated with the channel for the transmission signal.

7. The interference suppression wireless communication device according to claim 6, wherein
the radio receiver is configured to further calculate a delay spread of the reception signal,
the variance calculator is configured to further calculate, when communication is initiated and during the communication, errors according to granularity for transmitting the channel state information associated with the channel for the interference signal, and errors according to granularity for transmitting the channel state information associated with the channel for the transmission signal, and
the radio transmitter is configured to further transmit the errors according to the granularity for transmitting the channel state information associated with the channel for the interference signal, and the errors according to the granularity for transmitting the channel state information associated with the channel for the transmission signal.

8. The interference suppression wireless communication device according to claim 6, wherein
the radio receiver is configured to further calculate a maximum Doppler frequency of the reception signal,
the variance calculator is configured to further calculate, when communication is initiated and during the communication, a variance of the channel variation errors associated with the channel for the interference signal, and a variance of the channel variation errors associated with the channel for the transmission signal,
the radio transmitter is configured to further transmit the variance of the channel variation errors associated with the channel for the interference signal, and the variance of the channel variation errors associated with the channel for the transmission signal.

9. The interference suppression wireless communication device according to claim 1, further comprising:
a plurality of antennas,
wherein the radio signal generator is configured to simultaneously transmit a plurality of desired signals using the same frequency, and
the coefficient calculator is configured to calculate the coefficient using a variance of channel estimation errors associated with a channel for each of the plurality of desired signals and the variance of the noise.

10. An interference suppression wireless communication device to be used in an interference suppression wireless communication system, comprising:
a channel state information calculator configured to calculate a channel estimation value associated with a channel for an interference signal, and a channel estimation value associated with a channel for a transmission signal;
a variance calculator configured to calculate a variance of channel estimation errors associated with the channel for the transmission signal, a variance of channel estimation errors associated with the channel for the interference signal, and a variance of noise; and
a radio transmitter configured to transmit the channel estimation value associated with the channel for the interference signal, the channel estimation value associated with the channel for the transmission signal, the variance of the channel estimation errors associated with the channel for the transmission signal, the variance of the channel estimation errors associated with the channel for the interference signal, and the variance of noise.

11. An interference suppression wireless communication system, comprising:
a first communication device comprising:
an interference source transmission signal acquirer configured to receive an interference source transmission signal;
a radio receiver configured to receive channel state information associated with a channel for an interference signal;
an interference signal calculator configured to multiply the interference source transmission signal by the channel state information associated with the channel for the interference signal, to calculate an interference signal estimation value;
a variance acquirer configured to acquire at least one of a variance of channel estimation errors associated with the channel for the transmission signal and a variance of channel estimation errors associated with the channel for the interference signal, and acquire a variance of noise;
a coefficient calculator configured to calculate a coefficient based on the at least one of the variance of the channel estimation errors associated with the channel for the transmission signal and the variance of the channel estimation errors associated with the channel for the interference signal, and the variance of noise, which are acquired;
a coefficient multiplier configured to multiply the interference signal estimation value by the coefficient, to calculate a subtraction signal;
an interference signal subtractor configured to subtract the subtraction signal from a desired signal to be transmitted, to calculate a post-subtraction signal;
a modulo unit configured to divide the post-subtraction signal by a predetermined value to obtain a remainder, to calculate a power suppression transmission signal; and
a radio signal generator configured to transmit a transmission signal based on the power suppression transmission signal;
a second communication device comprising:
a channel state information calculator configured to calculate a channel estimation value associated with a channel for an interference signal, and a channel estimation value associated with a channel for a transmission signal;
a variance calculator configured to calculate a variance of channel estimation errors associated with the channel for the transmission signal, a variance of channel estimation errors associated with the channel for the interference signal, and a variance of noise; and
a radio transmitter configured to transmit the channel estimation value associated with the channel for the interference signal, the channel estimation value associated with the channel for the transmission signal, the variance of the channel estimation errors associated with the channel for the transmission signal, the variance of the channel estimation errors associated with the channel for the interference signal, and the variance of noise; and
a third communication device comprising:
a radio signal generator configured to transmit an interference signal; and
an interference source transmission signal notifier configured to transmit a transmission signal of the third communication device as an interference source transmission signal.

12. An interference suppression wireless communication system, comprising:
a first communication device comprising:
an interference signal calculator configured to acquire channel state information associated with a channel for an interference signal, and multiply a transmission signal of the first communication device by the channel state information associated with the channel for the interference signal, to calculate an interference signal estimation value;
a variance acquirer configured to acquire at least one of a variance of channel estimation errors associated with the channel for the transmission signal and a variance of channel estimation errors associated with the channel for the interference signal, and acquire a variance of noise;
a coefficient calculator configured to calculate a coefficient based on the at least one of the variance of the channel estimation errors associated with the channel for the transmission signal and the variance of the channel estimation errors associated with the channel for the interference signal, and the variance of noise, which are acquired;
a coefficient multiplier configured to multiply the interference signal estimation value by the coefficient to calculate a subtraction signal;
an interference signal subtractor configured to subtract the subtraction signal from a desired signal to be transmitted, to calculate a post-subtraction signal;
a modulo unit configured to divide the post-subtraction signal by a predetermined value to obtain a remainder, to calculate a power suppression transmission signal; and
a radio signal generator configured to transmit a transmission signal based on the power suppression transmission signal; and
a second communication device comprising:
a channel state information calculator configured to calculate a channel estimation value associated with a channel for an interference signal, and a channel estimation value associated with a channel for a transmission signal;
a variance calculator configured to calculate a variance of channel estimation errors associated with the channel for the transmission signal, a variance of channel estimation errors associated with the channel for the interference signal, and a variance of noise; and
a radio transmitter configured to transmit the channel estimation value associated with the channel for the interference signal, the channel estimation value associated with the channel for the transmission signal, the variance of the channel estimation errors associated with the channel for the transmission signal, the variance of the channel estimation errors associated with the channel for the interference signal, and the variance of noise.

13. The interference suppression wireless communication device according to claim 4, wherein
the variance acquirer is configured to generate, based on a method of transmitting the channel state information associated with the channel for the interference signal, the variance of the quantization errors in the channel state information associated with the channel for the interference signal, and
the variance acquirer is configured to generate, based on a method of transmitting the channel state information associated with the channel for the transmission signal, the variance of the quantization errors in the channel state information associated with the channel for the transmission signal.
